(19) United States
(12) Patent Application Publication
(10) Pub. No.: US 2025/0136144 A1
(43) Pub. Date: May 1, 2025

(54) Machine Learning Methods for Training Vehicle Perception Models Of A Second Class Of Vehicles Using Systems Of A First Class Of Vehicles

(71) Applicant: QUALCOMM Incorporated, San Diego, CA (US)

(72) Inventors: Seunghan YANG, Seoul (KR); Simyung CHANG, Suwon (KR); Minseop PARK, Young-in (KR); Jinkyu LEE, Seoul (KR)

(21) Appl. No.: 18/499,584

(22) Filed: Nov. 1, 2023

(51) Int. Cl. B60W 60/00

(52) U.S. Cl. CPC B60W 60/001; B60W 2554/4049

(57) ABSTRACT

Various embodiments may include methods, systems, and devices enabling a vehicle equipped with a complex sensor system encompassing low-end sensors of the second class of vehicles to train a low-end self-driving system. Various embodiments may include a processing system of the vehicle training the low-end self-driving system based on differences between outputs of a low-end self-driving sensor processing model generated based on the low-end sensors to outputs of a complex sensor processing model of the vehicle based on the vehicles complex sensor system. At least a portion of the trained self-driving system for the second class of vehicles may be provided to a remote server for deployment in the second class of vehicles.

### BACKGROUND

Automobiles and trucks are becoming more intelligent as the industry moves towards deploying autonomous and semi-autonomous vehicles. Autonomous and semi-autonomous vehicles can detect information about their location and surroundings (for example, using radar, lidar, GPS, file odometers, accelerometers, cameras, and other sensors), and include sophisticated processing systems that interpret sensory information to identify hazards and determine navigation paths to follow. Trained neural network systems and similar so-called artificial intelligence (AI) are being deployed to receive sensor data from a range of sensor types and sensing orientations to recognize and interpret objects and provide information regarding the roadway and surroundings that autonomous and semi-autonomous systems can use to make route planning, maneuvering, and other vehicle control decisions.

### SUMMARY

Various aspects include methods, processing systems, and devices enabling a first class of vehicle, such as an autonomous vehicle or semi-autonomous of a first class of vehicle for training self-driving systems for a second class of vehicles using sensors and self-driving systems of the first class of vehicles that includes a complex sensor system and a sensor system of the second class of vehicles. Various aspects may include comparing, in the first class of vehicle processing system, a first output of a sensor processing model for use in the second class of vehicles of a low-end self-driving system to a second output of a complex sensor processing model of the self-driving system of the first class of vehicle, training the sensor processing model for use in the second class of vehicles based on data from the sensor system of the second class of vehicles and the comparison of the first output of the sensor processing model for use in the second class of vehicles to the second output of the complex sensor processing model, and making the trained sensor processing model available for deployment in the second class of vehicles.

Some aspects may further include using data from the sensor system of the second class of vehicles in the sensor processing model for use in the second class of vehicles executing in the first class of vehicle processing system to generate the first output, and using data from the complex sensor system in the complex sensor processing model executing in the first class of vehicle processing system to generate the second output. In some aspects, training the sensor processing model for use in the second class of vehicles based on data from the sensor system of the second class of vehicles and the comparison of the first output of the sensor processing model for use in the second class of vehicles to the second output of the complex sensor processing model may include adjusting weights in a machine learning module of the sensor processing model for use in the second class of vehicles to reduce a difference identified in the comparison of the first output to the second output. In some aspects, training the sensor processing model for use in the second class of vehicles based on data from the sensor system of the second class of vehicles and the comparison of the first output of the sensor processing model for use in the second class of vehicles to the second output of the complex sensor processing model may include training a machine learning module of the sensor processing model for use in the second class of vehicles executing in the first class of vehicle processing system to reduce a knowledge distillation loss function based on the comparison.

Some aspects may further include periodically generating a consensus score that averages comparisons of multiple complex sensor processing model outputs to corresponding multiple outputs of the sensor processing model for use in the second class of vehicles, and performing the training of the sensor processing model for use in the second class of vehicles based on data from the sensor system of the second class of vehicles and the comparison of the first output of the sensor processing model for use in the second class of vehicles to the second output of the complex sensor processing model when the consensus score fails to satisfy an acceptability threshold.

In some aspects, the sensor processing model for use in the second class of vehicles and the complex sensor processing model may be one or more of line-detection models, object detection models, object detection segmentation models, human detection models, animal detection models, vehicle detection models, or distance or depth estimation models.

In some aspects, making the trained self-driving system available for deployment in the second class of vehicles may include transmitting at least a portion of the trained sensor processing model for use in the second class of vehicles to a remote server in a format that enables the remote server to deploy trained self-driving systems to the second class of vehicles. In some aspects, transmitting at least a portion of the trained sensor processing model for use in the second class of vehicles to the remote server may include transmitting a trained machine learning module of the trained sensor processing model for use in the second class of vehicles to the remote server. In some aspects, transmitting at least a portion of the trained sensor processing model for use in the second class of vehicles to the remote server may include transmitting at least a portion of the trained sensor processing model for use in the second class of vehicles to a remote server in a format that prevents disclosure of user privacy information.

Further aspects include a vehicle including a processing system configured with processor-executable instructions to perform operations of any of the methods summarized above. Further aspects include a non-transitory processor-readable storage medium having stored thereon processor-executable software instructions configured to cause a vehicle processing system to perform operations of any of the methods summarized above. Further aspects include a processing system for use in a vehicle and configured to perform operations of any of the methods summarized above. Further aspects may include a non-transitory processor-readable storage medium having stored thereon processor-executable instructions configured to cause a processing system to perform operations of any of the methods summarized above.

Some aspects may include methods of deploying self-driving systems trained in a first class of vehicles to a second class of vehicles, which may include receiving trained sensor processing model for use in the second class of vehicles from one or more first class of vehicles, generating a consolidated sensor processing model for use in the second class of vehicles from the received sensor processing model for use in the second class of vehicles, and providing at least the consolidated sensor processing model for use in the second class of vehicles to one or more second class of vehicles for use in a self-driving system. Some aspects may further include providing compensation to owners of the one or more the first class of vehicles in return for providing the trained sensor processing model for use in the second class of vehicles. Some aspects may further include generating a self-driving system based on the consolidated sensor processing model for use in the second class of vehicles, in which providing at least the consolidated sensor processing model for use in the second class of vehicles to one or more the second class of vehicles for use in a self-driving system may include providing the generated self-driving system to one or more the second class of vehicles.

Further aspects include a vehicle including a processing system configured with processor-executable instructions to perform operations of any of the methods summarized above. Further aspects include a non-transitory processor-readable storage medium having stored thereon processor-executable software instructions configured to cause a vehicle processing system to perform operations of any of the methods summarized above. Further aspects include a processing system for use in a vehicle and configured to perform operations of any of the methods summarized above. Further aspects may include a non-transitory processor-readable storage medium having stored thereon processor-executable instructions configured to cause a processing system to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIGS. 1A and 1B are component block diagrams illustrating a vehicle suitable for implementing various embodiments.

FIG. 1C is a component block diagram illustrating components of a vehicle suitable for implementing various embodiments.

FIG. 2A is a component block diagram illustrating components and processing modules of an example vehicle management system suitable for implementing some embodiments.

FIG. 2B is a component block diagram illustrating components and processing modules of another example vehicle management system suitable for implementing some embodiments.

FIG. 2C is a component block diagram illustrating components and processing modules of another example vehicle management system suitable for implementing some embodiments.

FIG. 3 is a block diagram illustrating components of an example processing system for use in a vehicle that may be configured to implement any of the various embodiments.

FIGS. 4A and 4B are component block diagrams illustrating non-limiting examples of computing systems, processing models and data flows for implementing various embodiments.

FIGS. 5A and 5B are process flow diagrams illustrating embodiment methods for using sensors and self-driving systems of a first class of vehicles to train self-driving system modules for a second class of vehicles.

FIG. 6 is a component diagram of an example server suitable for implementing some embodiments.

FIG. 7 is a process flow diagram illustrating an embodiment method for receiving trained self-driving system modules and deploying self-driving systems to a second class of vehicles.

### DETAILED DESCRIPTION

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

Various embodiments include methods, systems, and devices enabling a first class of vehicles equipped with complex sensor systems using the self-driving system of the first class of vehicles to train artificial intelligence/machine learning (AI/ML) models for self-driving systems for a second class of vehicles equipped with simplified sensor that are more affordable than the first class of vehicles.

A challenge faced by car manufacturers and fleet operators is to improve the performance and safety of the second class of vehicles in their product line without significantly increasing costs, including the costs of training self-driving AI/ML models. Various embodiments include methods, vehicles, vehicle management systems, and processing systems configured to enable a first class of autonomous or semi-autonomous vehicles to train AI/ML sensor processing models, and potentially other modules, for self-driving systems suitable for the second class of vehicles. Using various embodiments, vehicle manufacturers and fleet operators may leverage the driving experiences and extensive sensing and processing capabilities of the first class of vehicles to provide knowledge distillation training for the self-driving systems for the affordable second class of vehicles in their produce line. By using the first class of vehicles to train the AI/ML models for a second class of vehicles, manufacturers and fleet managers can sell/deploy two classes of vehicles while only having to invest in the training of the AI/ML models for one class (i.e., the first class). Thus, using various embodiments manufacturers or fleet managers may invest in training the AI/ML sensor processing models for the first class of vehicles, and then use the sold/deployed first class of vehicles to train the AI/ML sensor processing models for the second class of vehicles.

Vehicle manufacturers typically sell a product line that include a first class of expensive (e.g., high-end or luxury) vehicles equipped with many luxury and technology features, and a second class of less expensive (e.g., low-end or “economy”) vehicles equipped with far fewer technology features to enable the vehicles to be sold at a lower price point. The higher price of the first class of high-end/expensive vehicles enables manufactures to include a complex suite of sensors that provide data (e.g., camera images, radar data, lidar data, etc.) that can be used as inputs to an sensor processing model supplying object detection and classification information for supporting the vehicle's self-driving system. In contrast, the lower price of the second class of economy vehicles limits the number and types of sensors that can be included and used to support self-driving systems.

For ease of reference, the terms “first class of vehicle” and “second class of vehicle” are used herein to distinguish between a first category or classification of vehicles equipped with complex sensor suites plus the capabilities to train AI/ML models for use in a second category or classification of vehicles equipped with fewer, simpler, and/or less complex sensors (referred to herein as “simplified sensors”). The terms “complex sensors” and “simplified sensors” are used herein to distinguish between the complex suite of sensors included in the first class of vehicles from the fewer, simpler, and/or less complex sensors deployed in the second class of vehicles. Simplified sensors may be a limited suite of sensors that provide basic data to an AI/ML sensor processing model trained in the first class of vehicles to provide the processing capabilities required for self-driving systems deployed in the second class of vehicles.

In various embodiments, self-driving system modules for a second class of vehicles may be trained (qualified, calibrated, finetuned, etc.) in or in conjunction with high-end/complex self-driving systems deployed in the first class of vehicles that are equipped with both the same simplified sensors systems as a second class of vehicles as well as a more complex/extensive set of sensors. Leveraging the more extensive sensor systems deployed in the first class of vehicles may enable training processing modules that will received data from a less extensive set of sensors (“simplified sensor system”) using knowledge distillation techniques. Once trained (as well as retrained, refined, or updated), the trained self-driving system module for the second class of vehicles may be deployed in the second class vehicles, such as via an over-the-air update from a vehicle manufacturer or software provider. Using the first class of vehicles to train self-driving modules, such as the sensor processing module(s) for self-driving systems, enables the training a second class of vehicles to take place in the same locations where such vehicles may operate without the need for separate AI training investments dedicated to training a second class of sensor processing modules and/or self-driving systems.

The term “processing system” is used herein to refer to one more processors, including multi-core processors, that are organized and configured to perform various computing functions. Various embodiment methods may be implemented in one or more of multiple processors within a processing system as described herein.

As used herein, the terms “component,” “system,” “unit,” “module,” and the like include a computer-related entity, such as, but not limited to, hardware, firmware, a combination of hardware and software, software, neural network models, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions, neural network models, and/or data structures stored thereon. Components may communicate by way of local and/or remote processes, function or procedure calls, electronic signals, data packets, memory read/writes, and other known computer, processor, and/or process related communication methodologies.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) is used herein to refer to a single module or package that contains multiple resources, computational units, cores, or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

Various aspects make use of machine learning, neural network processing, and other artificial intelligence (AI) methods. Therefore, an overview of such technology and terms is provided.

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process that is performed at runtime or during the execution of the software application program corresponding to the neural network. Inference may include traversing the processing nodes in the neural network along a forward path to produce one or more values as an overall activation or overall “inference result.”

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in-between the input and final layer may be referred to as intermediate layers, hidden layers, or black-box layers.

Each layer in a neural network may have multiple inputs, and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

A convolutional neural network (CNN) is a class of deep neural networks in which the computation in at least one layer is structured as a convolution. A convolutional neural network may also include multiple convolution-based layers, which allows the neural network to employ a very deep hierarchy of layers. In convolutional neural networks, the weighted sum for each output activation is computed based on a batch of inputs, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations generate the overall inference result of the neural network, such as a probability that an image contains a specific object (e.g., a person, cat, watch, edge, etc.) or information indicating that a proposed action should be taken.

A recurrent neural network (RNN) is a class of neural networks particularly well-suited for sequence data processing. Unlike feedforward neural networks, RNNs may include cycles or loops within the network that allow information to persist. This enables RNNs to maintain a “memory” of previous inputs in the sequence, such as in a series of image frames from a camera system, which may be beneficial for tasks in which temporal dynamics and the context in which data appears are relevant.

The term “long short-term memory network” (LSTM) is used herein to refer to a specific type of RNN that addresses some of the limitations of basic RNNs, particularly the vanishing gradient problem. LSTMs include a more complex recurrent unit that allows for the easier flow of gradients during backpropagation. This facilitates the model's ability to learn from long sequences and remember over extended periods, making it apt for tasks such as language modeling, machine translation, and other sequence-to-sequence tasks.

The term “transformer” is used herein to refer to a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

The term “large generative AI model” (LXM) is used herein to refer to an advanced computational framework that includes any of a variety of specialized AI models including, but not limited to, large vision models (LVMs), large language models (LLMs), large speech models (LSMs), hybrid models, and multi-modal models. An LXM may include multiple layers of neural networks (e.g., RNN, LSTM, transformer, etc.) with millions or billions of parameters. Unlike traditional systems that translate user prompts into a series of correlated files or web pages for navigation, LXMs support dialogic interactions and encapsulate expansive knowledge in an internal structure. As a result, rather than merely serving a list of relevant websites, LXMs are capable of providing direct answers and/or are otherwise adept at various tasks, such as text summarization, translation, complex question-answering, conversational agents, etc. In various embodiments, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput. In some embodiments, the LXM component may be enhanced with or configured to perform an adaptive algorithm that allows the LXM to better understand context information and dynamic user behavior. In some embodiments, the adaptive algorithms may be performed by the same processing system that manages the core functionality of the LXM and/or may be distributed across multiple independent processing systems.

The term “embedding layer” is used herein to refer to a specialized layer within a neural network, typically at the input stage, that transforms discrete categorical values or tokens into continuous, high-dimensional vectors. An embedding layer may operate as a lookup table in which each unique token or category is mapped to a point in a continuous vector space. The vectors may be refined during the model's training phase to encapsulate the characteristics or attributes of the tokens in a manner that is conducive to the tasks the model is configured to perform.

The term “token” is used herein to refer to a unit of information that a generative AI model (e.g., LXM, etc.) may read as a single input during training and inference. Each token may represent any of a variety of different data types. For example, in text-centric models such as in LLMs, each token may represent a textual element such as a paragraph, sentence, clause, word, sub-word, character, etc. In models designed for auditory data, such as LSMs, each token may represent a feature extracted from audio signals, such as a phoneme, spectrogram, temporal dependency, Mel-frequency cepstral coefficients (MFCCs) that represent small segments of an audio waveform, etc. In visual models such as LVM, each token may correspond to a portion of an image (e.g., pixel blocks), sequences of video frames, etc. In hybrid systems that combine multiple modalities (text, speech, vision, etc.), each token may be a complex data structure that encapsulates information from various sources. For example, a token may include both textual and visual information, each of which independently contributes to the token's overall representation in the model.

There are generally limitations on the total number of tokens that may be processed by AI models. As an example, a model with a limitation of 512 tokens may alter or truncate input sequences that go beyond this specific count.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than 300 dimensions, etc.) in which each dimension in the vector captures a unique attribute, quality, or characteristic of the token. For example, dimension 1 of the numerical vector may encode the frequency of a word's occurrence in a corpus of data, dimension 2 may represent the pitch or intensity of the sound of the word at its utterance, dimension 3 may represent the sentiment value of the word, etc. Such intricate representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, recurrent neural networks (RNNs), or long short-term memory networks (LSTMs).

The term “sequence data processing” is used herein to refer to techniques or technologies for handling ordered sets of tokens in a manner that preserves their original sequential relationships and captures dependencies between various elements within the sequence. The resulting output may be a probabilistic distribution or a set of probability values, each corresponding to a “possible succeeding token” in the existing sequence. For example, in text completion tasks, the LXM may suggest the possible succeeding token determined to have the highest probability of completing the text sequence. For text generation tasks, the LXM may choose the token with the highest determined probability value to augment the existing sequence, which may subsequently be fed back into the model for further text production.

The terms “distillation” and “knowledge distillation” are used herein to refer to machine learning techniques of training a smaller or simpler model (often referred to as a “student” or “student model”) using the knowledge obtained from a larger or more complex model (often termed the “teacher” or “teacher module”). The teacher model, with its intricate and detailed understanding of the environment in which both models operate, produces outputs that contain extensive information useful for training the student model. By guiding the student model with outputs of the teach module, rather than the raw input data alone, the student model learns to emulate the behavior of the teacher model, achieving performance levels that the student model might not have reached with traditional training methods. For example, the output of a complex sensor processing module processing raw data from a complex, extensive sensor system may provide a baseline or knowledge distillation of processing camera, radar, lidar and other sensor data that a sensor processing model for use in the second class of vehicles can use to learn how to process or interpret data from a simplified (i.e., limited) sensor system to provide similar to or consistent outputs.

Autonomous and semi-autonomous vehicles, such as cars, trucks, tour buses, etc., are becoming a reality on city streets. Autonomous and semi-autonomous vehicles typically include a plurality of sensors, which may include cameras, radar, and lidar, that collect information about the environment surrounding the vehicle. For example, such collected information may enable the vehicle to recognize the roadway, identify and understand street signs and traffic lights, identify objects to avoid, and track the movement and future position of other vehicles to enable partial or fully autonomous navigation.

Autonomous vehicles are becoming increasingly sophisticated with advanced sensors and self-driving capabilities. However, there may soon be two main categories of self-driving cars: expensive vehicles equipped with complex sensor systems and self-driving systems, and less expensive (“affordable”) the second class of vehicles equipped with less expensive and less extensive sensor systems and self-driving systems.

In various embodiments, the first class of vehicles use both their complex sensor systems to support the vehicle's a complex self-driving system, and use the simplified sensor system (i.e., a sensor system deployed on the second class of vehicles) to train (using machine learning techniques) a simplified or self-driving system module, such as the sensor processing module. The simplified or self-driving system (or sensor processing module) is configured to be implemented on the second class of vehicles that are equipped with the same simplified sensor system. While the vehicle is operating, a training module in the first class of vehicle may compare the model output of the first class of vehicle self-driving system or a module of that system (e.g., navigation accuracy, object recognition, collision avoidance, etc.) to the output of the simplified vehicle self-driving system or a module of that system to determine whether and the extent to which the simplified model needs to be trained, retrained, or updated to produce similar results. Thus, in a processor referred to as knowledge distillation, the self-driving system for a second class of vehicles (or a module of that system) may be trained to process simplified sensor system data so as to emulate the results or output of the high-end self-driving system or module that processes data from the complex sensor system.

Using knowledge distillation training techniques, the complex sensor system and complex sensor processing module may provide an accurate rendering or representation of the world that may service as a ground truth for training low-end vehicle self-driving systems or modules for such systems to navigate the world using data from the simplified sensor systems. While the simplified sensor system does not provide as much data with the level of fidelity as the complex sensor systems, the use of machine learning to train the simplified vehicle self-driving system or sensor processing module may enable the self-driving system of the second class of vehicles to operate safely.

In some embodiments, the first class of vehicle systems may train, finetune, update or retrain the low-end-driving system or system model whenever outputs (e.g., predictions, resolutions, or other performance factors) of the sensor processing model for the second class of vehicles differ from outputs of the sensor processing model for the first class of vehicles by a threshold amount (referred to herein as an acceptability threshold).

Various embodiments may enable vehicle manufacturers to deploy safe autonomous driving systems in the second class of vehicles equipped with the simplified sensor systems. By training self-driving systems for the second class of vehicles in the real world using ground truth provided by higher fidelity sensors and the associated complex vehicle self-driving system of the first class of vehicles, such the second class of vehicles may operate safely using less expensive sensors. Various embodiments may enable manufacturers or ADS software providers to avoid the expense of training two different self-driving system. Further, the first class of vehicles can periodically update or refine the self-driving systems for the second class of vehicles, such as to address changes in roadway layouts and conditions without the need for investments in training the self-driving systems for the second class of vehicles.

In some embodiments, owners of the first class of vehicles may be compensated for permitting the training of self-driving systems for the second class of vehicles and/or for providing or permitting the trained systems or modules to be transmitted to the manufacturer for distribution to the second class of vehicles. Since the training of vehicle machine learning models has the potential of revealing personal information regarding driving routes and schedules, this compensation would reward the first class of vehicle owners for sharing such potentially personal information. However, in some embodiments, user privacy may be preserved by transmitting the machine learning model or elements of the model (e.g., neural network layer links and weights) but not the raw data used in training the model. Using over-the-air upload and download methods, such embodiments could provide a steady stream of income to participating high owners of the first class of vehicles as well as periodic updates to the autonomous driving systems of the second class of vehicles.

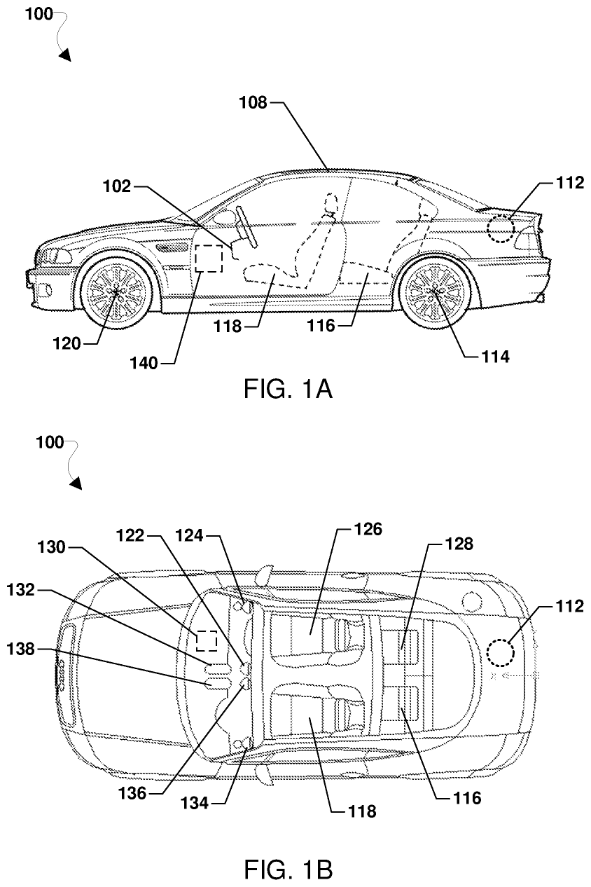

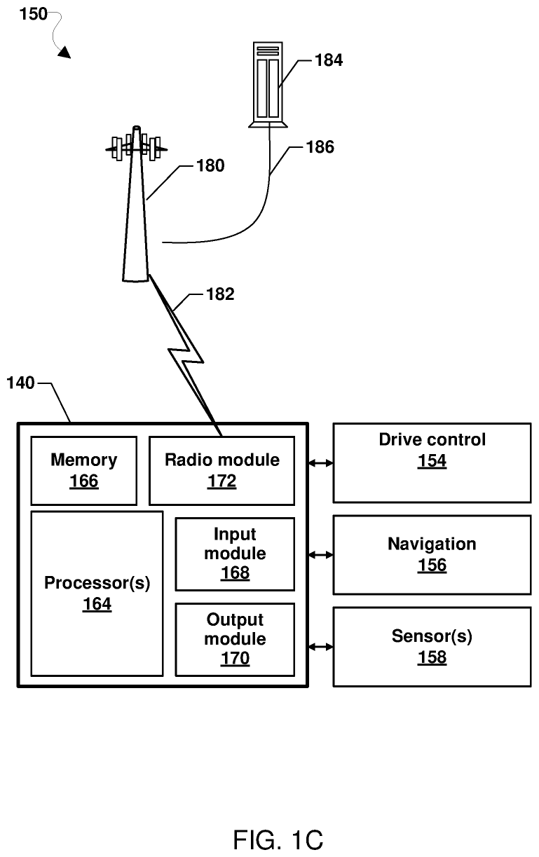

Various embodiments may be implemented within a variety of vehicles, an example vehicle 100 of which is illustrated in FIGS. 1A and 1B. With reference to FIGS. 1A and 1B, a vehicle 100 may include a processing system 140, and a plurality of sensors 102-138, including cameras 122, 136, radar 132, and lidar 138, as well as a suit of other sensors, such as satellite geopositioning system receivers 108, occupancy sensors 112, 116, 118, 126, 128, tire pressure sensors 114, 120, microphones 124, 134, impact sensors 130, etc. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation, collision avoidance, and autonomous and semi-autonomous navigation and control. Each of the sensors 102-138 may be in wired or wireless communication with the vehicle's processing system 140, as well as with each other.

In particular, the sensors may include one or more cameras 122, 136 or other optical sensors or photo optic sensors. Cameras 122, 136 or other optical sensors or photo optic sensors may include outward facing sensors imaging objects outside the vehicle 100 and/or in-vehicle sensors imaging objects (including passengers) inside the vehicle 100. In some embodiments, the vehicle may include multiple cameras, such as two frontal cameras with different fields of view (FOVs), four side cameras, and two rear cameras. The sensors may further include other types of object detection and ranging sensors, such as radar 132, lidar 138, IR sensors, and ultrasonic sensors. The sensors may be configured to provide data to a sensor processing module, which may be a neural network or AI model that has been trained to receive data from the sensors and output interpretations of the data (e.g., lane recognition, object recognition and classification, other vehicle locations and motion vectors, etc.) in a format useful by the vehicle self-driving system for safe navigation and operations.

The vehicle processing system 140 may be configured with processor-executable instructions to perform operations of some embodiments using information received from various sensors, particularly the cameras 122, 136. In some embodiments, the processing system 140 may supplement the processing of camera images using distance and relative position (e.g., relative bearing angle) that may be obtained from radar 132 and/or lidar 138 sensors. The processing system 140 may further be configured to control steering, breaking and speed of the vehicle 100 when operating in an autonomous or semi-autonomous mode using information regarding other vehicles determined based on sensor data.

FIG. 1C is a component block diagram illustrating a system 150 of components and support systems suitable for implementing some embodiments. With reference to FIGS. 1A-1C, a vehicle 100 may include a processing system 140, which may include or be coupled to various circuits and devices used to control the operation of the vehicle 100. In the example illustrated in FIG. 1C, the processing system 140 includes at least one processor 164, memory 166, an input module 168, an output module 170 and a radio module 172. The processing system 140 may be coupled to and configured to control drive control components 154, navigation components 156, and one or more sensors 158 of the vehicle 100.

The radio module 172 may be configured for wireless communication. The radio module 172 may exchange signals 182 (e.g., command signals for controlling maneuvering, signals from navigation facilities, etc.) with a network transceiver 180, and may provide the signals 182 to at least one processor 164 and/or the navigation unit 156.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The processing system 140 may be coupled to the drive control components 154 to control physical elements of the vehicle 100 related to maneuvering and navigation of the vehicle, such as the engine, motors, throttles, steering elements, flight control elements, braking or deceleration elements, and the like. The drive control components 154 may also include components that control other devices of the vehicle (e.g., processors of the wireless device 190 selected to perform augmented processing tasks, etc.), including environmental controls (e.g., air conditioning and heating), external and/or interior lighting, interior and/or exterior informational displays (which may include a display screen or other devices to display information such as a display of the wireless device 190), safety devices (e.g., haptic devices, audible alarms, etc.), and other similar devices.

The processing system 140 may be coupled to the navigation components 156, and may receive data from the navigation components 156 and be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control elements 154, the processing system 140 may control the vehicle 100 to navigate and maneuver. The processing system 140 and/or the navigation components 156 may be configured to communicate with a server 184 on a network 186 (e.g., the Internet) using a wireless connection 182 with a cellular data network 180 to receive commands to control maneuvering, receive data useful in navigation, provide real-time position reports, and assess other data.

While the processing system 140 is described as including separate components, in some embodiments some or all of the components (e.g., the at least one processor 164, the memory 166, the input module 168, the output module 170, and the radio module 172) may be integrated in a single device or module, such as a system-on-chip (SOC) processing system. Such an SOC processing system may be configured for use in vehicles and be configured, such as with processor-executable instructions executing in the at least one processor 164 of the processing system 140, to perform operations of various embodiments when installed into a vehicle.

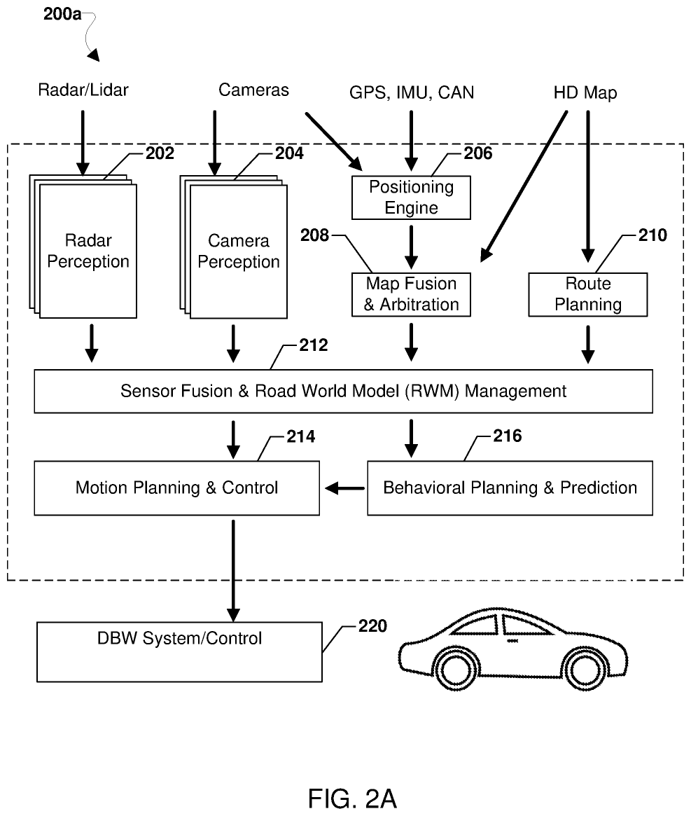

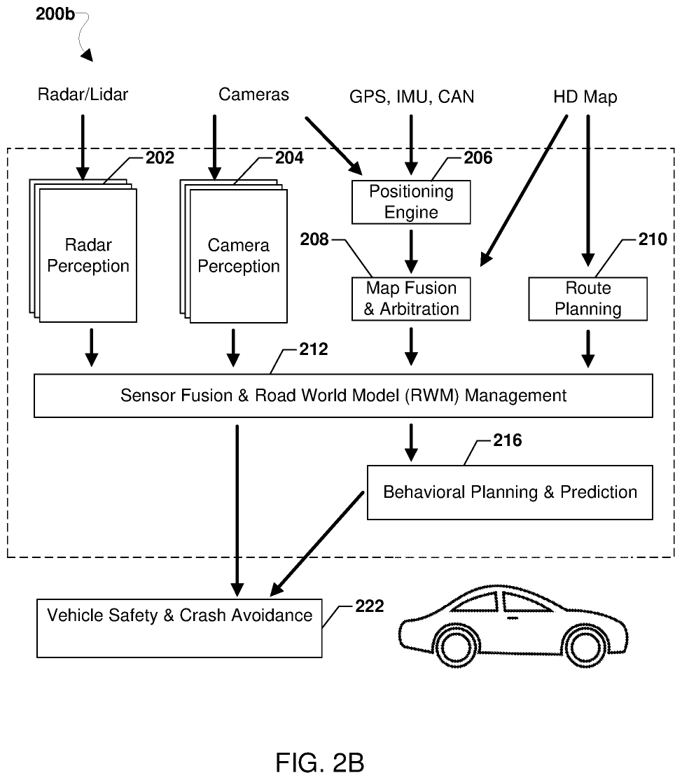

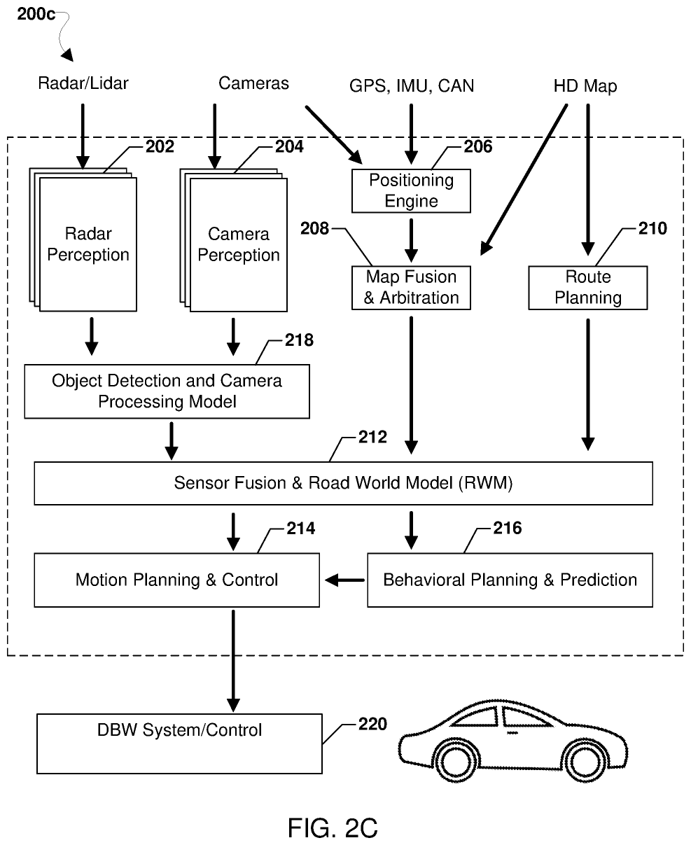

FIG. 2A illustrates an example of subsystems, computational elements, computing devices, or units within a vehicle management system 200a, which may be utilized within a vehicle 100. With reference to FIGS. 1A-2A, in some embodiments, the various computational elements, computing devices or units within vehicle management system 200a may be implemented within a system of interconnected computing devices (i.e., subsystems), that communicate data and commands to each other (e.g., indicated by the arrows in FIG. 2A). In other embodiments, the various computational elements, computing devices, or units within vehicle management system 200a may be implemented within a single computing device, such as separate neural network models, threads, processes, algorithms, or computational elements. Therefore, each subsystem/computational element illustrated in FIG. 2A is also generally referred to herein as “layer” within a computational “stack” that constitutes the vehicle management system 200a. However, the use of the terms layer and stack in describing various embodiments are not intended to imply or require that the corresponding functionality is implemented within a single autonomous (or semi-autonomous) vehicle management system computing device, although that is a potential implementation embodiment. The use of the term “layer” is intended to encompass subsystems with independent processors, computational elements (e.g., trained models, threads, algorithms, subroutines, etc.) running in one or more computing devices, and combinations of subsystems and computational elements.

In some embodiments, the vehicle management system stack 200a may include a radar perception layer 202, a camera perception layer 204, a positioning engine layer 206, a map fusion and arbitration layer 208, a route planning layer 210, sensor fusion and road world model (RWM) management layer 212, motion planning and control layer 214, and behavioral planning and prediction layer 216. The layers 202-216 are merely examples of some layers in one example configuration of the vehicle management system stack 200a. Other layers may be included, such as additional layers for other perception sensors (e.g., LiDAR perception layer, etc.), additional layers for planning and/or control, additional layers for modeling, etc., and/or certain of the layers 202-216 may be excluded from the vehicle management system stack 200a. Each of the layers 202-216 may exchange data, computational results, and commands with one another. Examples of some interactions between the layers 202-216 are illustrated by the arrows in FIG. 2A.

The vehicle management system stack 200a may receive and process data from sensors (e.g., radar, lidar, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The processing of such sensor data may be performed in a sensor processing module, which in some embodiments is a trained neural network or AI module. This sensor processing module may execute within the vehicle's processing system, such as in a neural network model executing in the processing system, or within a separate processing system, such as a DNN processing system designed for AI-type processing (e.g., CNN, RNN, etc.).

The vehicle management system stack 200a may output vehicle control commands or signals to the drive by wire (DBW) system/processing system 220, which is a system, subsystem or computing device that interfaces directly with vehicle steering, throttle, and brake controls. The configuration of the vehicle management system stack 200a and DBW system/processing system 220 illustrated in FIG. 2A is merely an example configuration and other configurations of a vehicle management system and other vehicle components may be used in some embodiments. As an example, the configuration of the vehicle management system stack 200a and DBW system/processing system 220 illustrated in FIG. 2A may be used in a vehicle configured for autonomous or semi-autonomous operation while a different configuration may be used in a non-autonomous vehicle.

The radar perception layer 202 may receive data from one or more detection and ranging sensors, such as radar (e.g., 132) and/or lidar (e.g., 138), and process the data to recognize and determine locations of other vehicles and objects within a vicinity of the vehicle 100. The radar perception layer 202 may include use of neural network processing and artificial intelligence methods to recognize objects and vehicles, and pass such information on to the sensor fusion and RWM trained model 212.

The camera perception layer 204 may receive data from one or more cameras, such as cameras (e.g., 122, 136), and process the data to recognize and determine locations of other vehicles and objects within a vicinity of the vehicle 100 and/or inside the vehicle 100 (e.g., passengers, etc.). The camera perception layer 204 may include use of neural network processing and artificial intelligence methods to recognize objects and vehicles, and pass such information on to the sensor fusion and RWM trained model 212 and/or other layers.

The positioning engine layer 206 may receive data from various sensors and process the data to determine a position of the vehicle 100. The various sensors may include, but is not limited to, GPS sensor, an IMU, and/or other sensors connected via a CAN bus. The positioning engine layer 206 may also utilize inputs from one or more cameras, such as cameras (e.g., 122, 136) and/or any other available sensor, such as radars, LIDARs, etc.

The map fusion and arbitration layer 208 may access data within a high definition (HD) map database and receive output received from the positioning engine layer 206 and process the data to further determine the position of the vehicle 100 within the map, such as location within a lane of traffic, position within a street map, etc. The HD map database may be stored in a memory (e.g., memory 166). For example, the map fusion and arbitration layer 208 may convert latitude and longitude information from GPS into locations within a surface map of roads contained in the HD map database. GPS position fixes include errors, so the map fusion and arbitration layer 208 may function to determine a best guess location of the vehicle within a roadway based upon an arbitration between the GPS coordinates and the HD map data. For example, while GPS coordinates may place the vehicle near the middle of a two-lane road in the HD map, the map fusion and arbitration layer 208 may determine from the direction of travel that the vehicle is aligned with the travel lane consistent with the direction of travel. The map fusion and arbitration layer 208 may pass map-based location information to the sensor fusion and RWM trained model 212.

The route planning layer 210 may utilize the HD map, as well as inputs from an operator or dispatcher to plan a route to be followed by the vehicle 100 to a particular destination. The route planning layer 210 may pass map-based location information to the sensor fusion and RWM trained model 212. However, the use of a prior map by other layers, such as the sensor fusion and RWM trained model 212, etc., is not required. For example, other stacks may operate and/or control the vehicle based on perceptual data alone without a provided map, constructing lanes, boundaries, and the notion of a local map as perceptual data is received.

The sensor fusion and RWM trained model 212 may receive data and outputs produced by the radar perception layer 202, camera perception layer 204, map fusion and arbitration layer 208, and route planning layer 210, and use some or all of such inputs to estimate or refine the location and state of the vehicle 100 in relation to the road, other vehicles on the road, and other objects within a vicinity of the vehicle 100 and/or inside the vehicle 100. For example, the sensor fusion and RWM trained model 212 may combine imagery data from the camera perception layer 204 with arbitrated map location information from the map fusion and arbitration layer 208 to refine the determined position of the vehicle within a lane of traffic. As another example, the sensor fusion and RWM trained model 212 may combine object recognition and imagery data from the camera perception layer 204 with object detection and ranging data from the radar perception layer 202 to determine and refine the relative position of other vehicles and objects in the vicinity of the vehicle. As another example, the sensor fusion and RWM trained model 212 may receive information from vehicle-to-vehicle (V2V) communications (such as via the CAN bus) regarding other vehicle positions and directions of travel, and combine that information with information from the radar perception layer 202 and the camera perception layer 204 to refine the locations and motions of other vehicles. As another example, the sensor fusion and RWM trained model 212 may apply facial recognition techniques to images to identify specific facial patterns inside and/or outside the vehicle.

The sensor fusion and RWM trained model 212 may output refined location and state information of the vehicle 100, as well as refined location and state information of other vehicles and objects in the vicinity of the vehicle 100 or inside the vehicle 100, to the motion planning and control layer 214, and/or the behavior planning and prediction layer 216.

As a further example, the sensor fusion and RWM trained model 212 may use dynamic traffic control instructions directing the vehicle 100 to change speed, lane, direction of travel, or other navigational element(s), and combine that information with other received information to determine refined location and state information. The sensor fusion and RWM trained model 212 may output the refined location and state information of the vehicle 100, as well as refined location and state information of other vehicles and objects in the vicinity of the vehicle 100 or inside the vehicle 100, to the motion planning and control layer 214, the behavior planning and prediction layer 216, and/or devices remote from the vehicle 100, such as a data server, other vehicles, etc., via wireless communications, such as through inter-vehicle communications, other wireless connections, etc.

The refined location and state information may include vehicle descriptors associated with the vehicle and the vehicle owner and/or operator, such as: vehicle specifications (e.g., size, weight, color, on board sensor types, etc.); vehicle position, speed, acceleration, direction of travel, attitude, orientation, destination, fuel/power level(s), and other state information; vehicle emergency status (e.g., is the vehicle an emergency vehicle or private individual in an emergency); vehicle restrictions (e.g., heavy/wide load, turning restrictions, high occupancy vehicle (HOV) authorization, etc.); capabilities (e.g., all-wheel drive, four-wheel drive, snow tires, chains, connection types supported, on board sensor operating statuses, on board sensor resolution levels, etc.) of the vehicle; equipment problems (e.g., low tire pressure, weak breaks, sensor outages, etc.); owner/operator travel preferences (e.g., preferred lane, roads, routes, and/or destinations, preference to avoid tolls or highways, preference for the fastest route, etc.); permissions to provide sensor data to a data agency server (e.g., 184); and/or owner/operator identification information.

The behavioral planning and prediction layer 216 of the autonomous vehicle system stack 200a may use the refined location and state information of the vehicle 100 and location and state information of other vehicles and objects output from the sensor fusion and RWM trained model 212 to predict future behaviors of other vehicles and/or objects. For example, the behavioral planning and prediction layer 216 may use such information to predict future relative positions of other vehicles in the vicinity of the vehicle based on own vehicle position and velocity and other vehicle positions and velocity. Such predictions may take into account information from the HD map and route planning to anticipate changes in relative vehicle positions as host and other vehicles follow the roadway. The behavioral planning and prediction layer 216 may output other vehicle and object behavior and location predictions to the motion planning and control layer 214. Additionally, the behavior planning and prediction layer 216 may use object behavior in combination with location predictions to plan and generate control signals for controlling the motion of the vehicle 100. For example, based on route planning information, refined location in the roadway information, and relative locations and motions of other vehicles, the behavior planning and prediction layer 216 may determine that the vehicle 100 needs to change lanes and accelerate, such as to maintain or achieve minimum spacing from other vehicles, and/or prepare for a turn or exit. As a result, the behavior planning and prediction layer 216 may calculate or otherwise determine a steering angle for the wheels and a change to the throttle setting to be commanded to the motion planning and control layer 214 and DBW system/processing system 220 along with such various parameters necessary to effectuate such a lane change and acceleration. One such parameter may be a computed steering wheel command angle.

The motion planning and control layer 214 may receive data and information outputs from the sensor fusion and RWM trained model 212 and other vehicle and object behavior as well as location predictions from the behavior planning and prediction layer 216, and use this information to plan and generate control signals for controlling the motion of the vehicle 100 and to verify that such control signals meet safety requirements for the vehicle 100. For example, based on route planning information, refined location in the roadway information, and relative locations and motions of other vehicles, the motion planning and control layer 214 may verify and pass various control commands or instructions to the DBW system/processing system 220.

The DBW system/processing system 220 may receive the commands or instructions from the motion planning and control layer 214 and translate such information into mechanical control signals for controlling wheel angle, brake, and throttle of the vehicle 100. For example, DBW system/processing system 220 may respond to the computed steering wheel command angle by sending corresponding control signals to the steering wheel controller.

The DBW system/processing system 220 may receive data and information outputs from the motion planning and control layer 214 and/or other layers in the vehicle management system stack 200a, and based on the received data and information outputs determine whether an event a decision maker in the vehicle 100 is to be notified about is occurring.

In some embodiments, the vehicle management system stack 200a may include functionality that performs safety checks or oversight of various commands, planning or other decisions of various layers that could impact vehicle and occupant safety. Such safety check or oversight functionality may be implemented within a dedicated layer or distributed among various layers and included as part of the functionality. In some embodiments, a variety of safety parameters may be stored in memory and the safety checks or oversight functionality may compare a determined value (e.g., relative spacing to a nearby vehicle, distance from the roadway centerline, etc.) to corresponding safety parameter(s), and issue a warning or command if the safety parameter is or will be violated. For example, a safety or oversight function in the behavior planning and prediction layer 216 (or in a separate layer) may determine the current or future separate distance between another vehicle (as refined by the sensor fusion and RWM trained model 212) and the vehicle (e.g., based on the world model refined by the sensor fusion and RWM trained model 212), compare that separation distance to a safe separation distance parameter stored in memory, and issue instructions to the motion planning and control layer 214 to speed up, slow down or turn if the current or predicted separation distance violates the safe separation distance parameter. As another example, safety or oversight functionality in the motion planning and control layer 214 (or a separate layer) may compare a determined or commanded steering wheel command angle to a safe wheel angle limit or parameter, and issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

FIG. 2B illustrates an example of subsystems, computational elements, computing devices or units within a vehicle management system 200b, which may be utilized within a vehicle 100. With reference to FIGS. 1A-2B, in some embodiments, the layers 202, 204, 206, 208, 210, 212, and 216 of the vehicle management system stack 200a may be similar to those described with reference to FIG. 2A and the vehicle management system stack 200b may operate similar to the vehicle management system stack 200a, except that the vehicle management system stack 200b may pass various data or instructions to a vehicle safety and crash avoidance system 222 rather than the DBW system/processing system 220. For example, the configuration of the vehicle management system stack 200b and the vehicle safety and crash avoidance system 222 illustrated in FIG. 2B may be used in a non-autonomous vehicle.

In some embodiments, the behavioral planning and prediction layer 216 and/or sensor fusion and RWM trained model 212 may output data to the vehicle safety and crash avoidance system 222. For example, the sensor fusion and RWM trained model 212 may output sensor data as part of refined location and state information of the vehicle 100 provided to the vehicle safety and crash avoidance system 222. The vehicle safety and crash avoidance system 222 may use the refined location and state information of the vehicle 100 to make safety determinations relative to the vehicle 100 and/or occupants of the vehicle 100. As another example, the behavioral planning and prediction layer 216 may output behavior models and/or predictions related to the motion of other vehicles to the vehicle safety and crash avoidance system 222. The vehicle safety and crash avoidance system 222 may use the behavior models and/or predictions related to the motion of other vehicles to make safety determinations relative to the vehicle 100 and/or occupants of the vehicle 100.

In some embodiments, the vehicle safety and crash avoidance system 222 may include functionality that performs safety checks or oversight of various commands, planning, or other decisions of various layers, as well as human driver actions, that could impact vehicle and occupant safety. In some embodiments, a variety of safety parameters may be stored in memory and the vehicle safety and crash avoidance system 222 may compare a determined value (e.g., relative spacing to a nearby vehicle, distance from the roadway centerline, etc.) to corresponding safety parameter(s), and issue a warning or command if the safety parameter is or will be violated. For example, a vehicle safety and crash avoidance system 222 may determine the current or future separate distance between another vehicle (as refined by the sensor fusion and RWM trained model 212) and the vehicle (e.g., based on the world model refined by the sensor fusion and RWM trained model 212), compare that separation distance to a safe separation distance parameter stored in memory, and issue instructions to a driver to speed up, slow down or turn if the current or predicted separation distance violates the safe separation distance parameter. As another example, a vehicle safety and crash avoidance system 222 may compare a human driver's change in steering wheel angle to a safe wheel angle limit or parameter, and issue an override command and/or alarm in response to the steering wheel angle exceeding the safe wheel angle limit.

The vehicle safety and crash avoidance system 222 may receive data and information outputs from the sensor fusion and RWM trained model 222, the behavior planning and prediction layer 216, and/or other layers in the vehicle management system stack 200a, and based on the received data and information outputs determine whether an event a decision maker in the vehicle 100 is to be notified about is occurring.

FIG. 2C illustrates another example of subsystems, computational elements, computing devices, or units within a vehicle management system 200c, which may be utilized within a vehicle 100, in accordance with some embodiments. With reference to FIGS. 1A-2C, in some embodiments, the layers 202, 204, 206, 208, 210, 212, and 216 of the vehicle management system stack 200c may be similar to those described with reference to FIG. 2A, except that the vehicle management system stack 200c includes a separate sensor processing module in the form of an object detection and camera processing model 218 that processes sensor data from vehicle sensors focused on the exterior of the vehicle, including lidar 138, radar 132, and multiple cameras, and provides an output to the RWM model 212. In this embodiment, the RWM model 212 does not have to be trained to recognize objects and roadway features based on vehicle sensor data, and instead trained to use the output of the object detection and camera processing model 218 in conjunction with outputs of the map fusion & arbitration layer 208 and route planning layer 210.

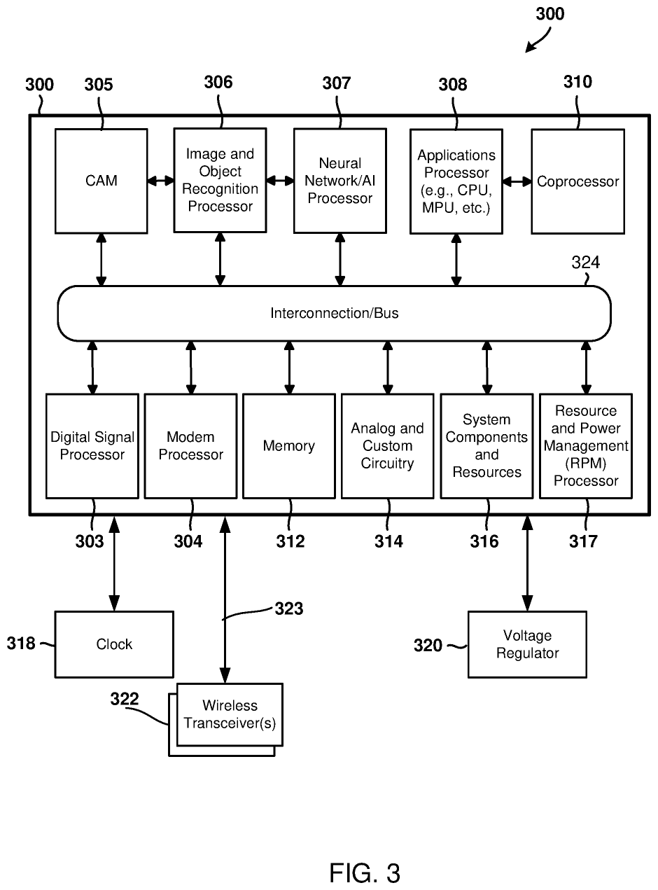

FIG. 3 illustrates an example system-on-chip (SOC) architecture of a processing system SOC 300 suitable for implementing various embodiments in vehicles. With reference to FIGS. 1A-3, the processing system SOC 300 may include a number of heterogeneous processors, such as a digital signal processor (DSP) 303, a modem processor 304, an image and object recognition processor 306, a neural network/AI processor 307, an applications processor 308, and a resource and power management (RPM) processor 317. The processing system SOC 300 may also include one or more coprocessors 310 (e.g., vector co-processor) connected to one or more of the heterogeneous processors 303, 304, 306, 307, 308, 317. Each of the processors may include one or more cores, and an independent/internal clock. Each processor/core may perform operations independent of the other processors/cores. For example, the processing system SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing system SOC 300 may include analog circuitry and custom circuitry 314 for managing sensor data, analog-to-digital conversions, wireless data transmissions, and for performing other specialized operations, such as processing encoded audio and video signals for rendering in a web browser. The processing system SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing system SOC 300 also include specialized circuitry for camera actuation and management (CAM) 305 that includes, provides, controls and/or manages the operations of one or more cameras 122, 136 (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in some embodiments. For example, the image and object recognition processor 306 may be configured to perform the operations of processing images received from cameras (e.g., 122, 136) via the CAM 305 to recognize and/or identify other vehicles, perform facial recognition, and otherwise perform functions of the camera perception layer 204 as described. In some embodiments, the processing system 306 may be configured to process radar or lidar data and perform functions of the radar perception layer 202 as described.

The system components and resources 316, analog and custom circuitry 314, and/or CAM 305 may include circuitry to interface with peripheral devices, such as cameras 122, 136, radar 132, lidar 138, electronic displays, wireless communication devices, external memory chips, etc. The processors 303, 304, 306, 307, 308 of a processing system may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing system SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.). The processing system SOC 300 may further include one or more wireless transceivers 322 configured to send and receive wireless communications via an antenna (not shown) to/from wireless device (e.g., wireless device 190). In some embodiments, the wireless transceivers 322 may be wireless transceivers configured to support peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), Bluetooth communications, Wi-Fi communications, etc. In some embodiments, the wireless transceivers 322 may be connected to the processing system SOC 300 by various physical connections 323 (also referred to as interconnects, buses, etc.), such as peripheral component interconnect express (PCIe) connections, universal serial bus (USB) connections, high speed inter-chip (HSIC) connections, Ethernet connections, etc. In various embodiments, the processing system SOC 300 may be configured to selectively send data, such as IP packets, to the wireless transceivers 322 using different ones of the connections 323.

In some embodiments, the processing system SOC 300 may be included in a processing system (e.g., 140) for use in a vehicle (e.g., 100). The processing system may include communication links for communication with a telephone network (e.g., 180), the Internet, and/or a network server (e.g., 184) as described.

The processing system SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, Wi-Fi, etc.), and other well-known components of modern electronic devices.

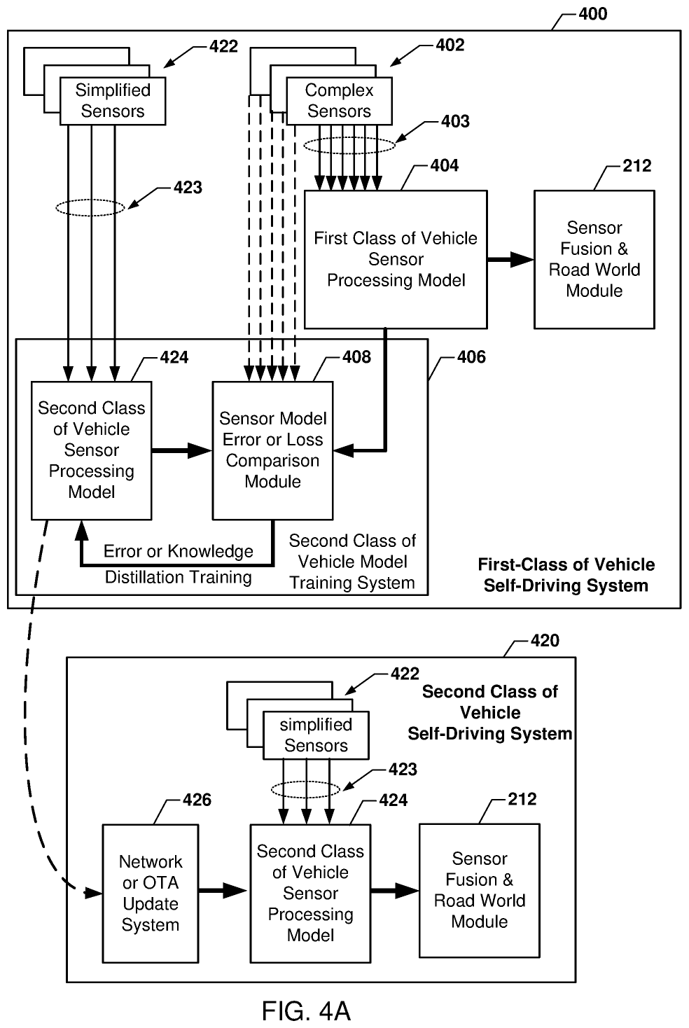

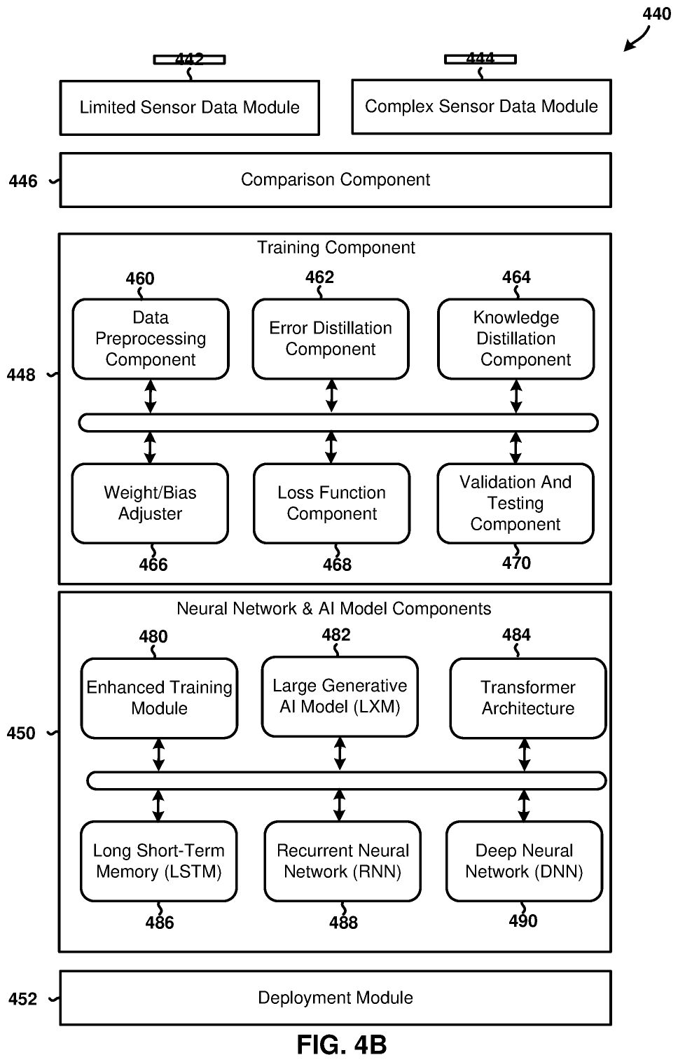

FIG. 4A is component and process block diagram illustrating various elements and processes involved in various embodiments including components and processing modules of a self-driving system 400 of the first class of vehicles and of a vehicle self-driving system 420 for the second class of vehicles.

With reference to FIGS. 1A-4A, a self-driving system 400 of the first class of vehicles may include complex sensors 402 configured to provide data 403 to a complex sensor processing model 404 (e.g., a trained neural network of an object detection and camera processing module 218) that provides an output that is usable by a vehicle control system, such as a sensor fusion & road world module 212 as described with reference to FIG. 2A.

In various embodiments, vehicle self-driving systems of the first class of vehicle may also include the sensors and training system necessary to training a low and sensor processing model as described herein. In particular, a vehicle of the first class may include a the second class of model training system 406 and a suite of simplified sensors 422 that includes the same number and type of sensors that may be deployed in the second class of vehicles. The simplified sensors 422 may be configured to provide sensor data 423 to a sensor processing model for use in the second class of vehicles 424 (i.e., a model being trained) within the low-end model training system.

In addition to the sensor processing model for use in the second class of vehicles 424 being trained, the low-end model training system 406 may include a sensor model error or loss comparison module 408. The sensor model error or loss comparison module 408 may be configured to receive an output from the sensor processing model for use in the second class of vehicles 424 (sometimes referred to herein as a “first output”) and an output from the complex sensor processing model 404 (sometimes referred to herein as a “second output”), and compare the two outputs to determine an error or “loss” in the low-end model output. Such comparisons may address multiple different types of model outputs, such as line detection, roadway following, object detection, object recognition, and other process output useful for self-driving systems.

The sensor model error or loss comparison module 408 may be further configured use the comparisons to generate information that is directly useful for training the sensor processing model for use in the second class of vehicles 402. In some embodiments, comparisons may be used to generate knowledge distillation information in which the complex sensor processing model 404 serves as a teacher model, and the sensor model error or loss comparison module 408 produces outputs that contain information useful for training the sensor processing model for use in the second class of vehicles 424 functioning as a student model. By providing the sensor processing model for use in the second class of vehicles 424 with comparisons of results of the complex sensor processing model 404, rather than just the raw sensor data 423, the sensor processing model for use in the second class of vehicles 424 may be trained to emulate the behavior (i.e., output) of the complex sensor processing model 404. In some embodiments, the sensor model error or loss comparison module 408 may also receive some sensor data from the complex sensors 402 of the vehicle if such data is useful in generating knowledge distillation training information. In some embodiments, the comparison made by the sensor model error or loss comparison module 408 may generate an error or loss value. This error or loss value may be fed back to the sensor processing model for use in the second class of vehicles 424 in a “backpropagation” training process to adjust weights in a machine learning model within the sensor processing model for use in the second class of vehicles to reduce a difference identified in the comparison of the first output to the second output.

Once the sensor processing model for use in the second class of vehicles 424 has been trained, that model (or weights and other elements of the model) may be provided to the second class of vehicles self-driving systems 420, such as via over-the-air (OTA) update procedures. For example, the low and sensor processing model 424 may be received by a network or OTA update system 426, which may be configured to provide or update the sensor processing model for use in the second class of vehicles 424 within the vehicle self-driving system 420. Thereafter, the installed or updated sensor processing model for use in the second class of vehicles 424 may receive sensor data 423 from the simplified sensors 424 within the vehicle, and provide outputs to the sensor fusion & road world module 212 to support self-driving operations as described herein.

FIG. 4B illustrates a non-limiting example of vehicle computing system 440 of the first class of vehicles that may be suitable for implementing various embodiments. The example computing system 440 includes a simplified sensor data module 442 for receiving, buffering, preprocessing and otherwise providing an interface between the simplified sensor system and the computing system, a complex sensor data module 444 for receiving, buffering, preprocessing and otherwise providing an interface between the complex sensor system and the computing system, a comparison component 446, a training component 448, a neural network and AI model component 450, and a deployment module 452. The training component 448 may include a data preprocessing component 460, an error distillation component 462, a knowledge distillation component 464, a weight/bias adjuster 466, a loss function component 468, and a validation and testing component 470. The neural network and AI model component 450 may include an enhanced training module 480, a large generative AI model (LXM) 482, a transformer architecture 484, a long short-term memory (LSTM) 486, a recurrent neural network (RNN) 488, and a deep neural network (DNN) 490.

The simplified sensor data module 442 may be configured to retrieve and process data from the sensor system of the second class of vehicles to generate a first self-driving sensor processing model (e.g., simplified sensor driving model). The first self-driving sensor processing model may be a preliminary model for self-driving operations, encompassing functionalities such as line detection, object discernment, and object segmentation.

The complex sensor data module 444 may be configured to retrieve and process data from more sophisticated and complex sensors of a the first class of vehicle and generate a second self-driving sensor processing model (e.g., complex sensor driving model). The second self-driving sensor processing model may be a more sophisticated or more refined self-driving model and/or may encompass more advanced functionalities than the first self-driving sensor processing model.

The comparison component 446 may be configured to compare the first and the second self-driving sensor processing models to generate comparison results, identify discrepancies or divergences, and generate a consensus score based on the comparisons of multiple outputs of the complex sensor processing model to the corresponding outputs of the sensor processing model for the second class of vehicles. In some embodiments, the consensus score may be a numerical representation of the disparity between the two systems or a quantifiable metric on how closely the simplified sensor processing model aligns with the complex sensor processing model that may be used for subsequent training and refinement of the models. In some embodiments, the comparison component 446 may generate the consensus score by averaging the comparisons of several outputs from the complex sensor processing model to corresponding outputs from the simplified sensor processing model. For example, the comparison component 446 may evaluate the trajectory predictions of both models to determine a divergence between a second class model prediction of a straight path for a vehicle and a first class model prediction that the vehicle's path will veer left in the next 3 seconds. The comparison component 446 may aggregate the results of evaluating hundreds of similar scenarios and set the consensus score equal to the percentage in which the second class vehicle model deviates from the first class vehicle model across all detected entities and their predicted trajectories.

The training component 448 may be configured to determine whether the consensus score exceeds a predetermined acceptability threshold. In response to determining that the consensus score does not exceed a predetermined acceptability threshold, the training component 448 may finetune or refine the low-end self-driving model based on the comparison results and the sensor data of the second class of vehicles.

The data preprocessing component 460 may be configured to clean/scrub and normalize the incoming sensor data to remove anomalies, categorize the data into distinct sets for training, validation, and testing, and convert the data into tensor transformations or another format suitable for training a neural network.

The error distillation component 462 may analyze the discrepancies between the outputs of the second class vehicle sensor processing model and first class vehicle sensor processing models to identify cases in which the outputs differ from predictions, prioritize discrepancies in which the system predictions deviate significantly, and use these prioritized discrepancies as additional training data to improve the accuracy and precision for the models in those specific scenarios. For example, a discrepancy of 5 meters may be given higher priority than a discrepancy is 0.2 meters due to its larger impact on autonomous driving safety and functionality. As such, rather than performing generic operations to improve the overall performance of the second class vehicles sensor processing model, the error distillation component 462 may focus on the specific areas of discrepancy for more targeted training operations.

The knowledge distillation component 464 may use the complex sensor processing model and self-driving system of the first class of vehicles as a “teacher model” and the simplified sensor processing model and self-driving system of the second class of vehicles as a “learner model” or “student model.” The knowledge distillation component 464 may transfer knowledge from the complex sensor processing model to the simplified sensor processing model by using the output/activation from the teacher model to guide the training of the learner model. The knowledge transfer may allow the simplified sensor processing model to achieve performance levels closer to the complex sensor processing model without the computational complexity of the complex sensor processing model.

For example, in an urban environment, a complex sensor processing model (teacher model) may perform resource-intensive analysis operations to evaluate intricate details such as the shadows cast by pedestrians, their reflections in storefront windows, or the subtle movements of clothing to detect and predict pedestrian movement with a high degree of accuracy. On the other hand, the simplified sensor processing model (learner model) may detect pedestrians based solely on basic shapes and movement patterns. The knowledge distillation component 464 may use the more accurate and nuanced understanding of the teacher model and impart it to the learner model. For example, rather than determining the subtleties of reflections and shadows, the learner model may use the output from the teacher model to identify the areas or features on which to focus its training operations. As a result, when the learner model encounters a similar scenario, it may already have information suitable for interpreting reflections or shadows as potential indicators of pedestrians. Such knowledge transfer may equip the learner model with a deeper understanding of various scenarios, enhancing its performance. Since it does not have to compute these intricate details from scratch, the learner model remains efficient and less resource-intensive than the teacher model. As a result, the simplified sensor processing model becomes better equipped to handle complex scenarios while still maintaining its computational efficiency.

The weight/bias adjuster 466 may adjust weights and biases in the neural network layers. The loss function component 468 may implement a loss function (e.g., mean squared error, cross-entropy, etc.) adjusted for distillation to reduce discrepancies between predicted and actual outputs of the neural network, and iteratively adjust network parameters based on the gradient of the loss function.

The validation and testing component 470 may validate the trained model against a validation set to monitor performance and avoid overfitting, use the test set to evaluate the model after completion of training, etc.

The enhanced training module 480 may be configured to perform forward propagation operations that include passing input data through the neural network layers to produce an output. Each layer may process the input, apply a weight, add a bias, and apply an activation function to generate a predicted output. The enhanced training module 480 may use backward propagation to adjust model parameters based on the loss, use techniques like batch normalization, dropout, and regularization to enhance model training and prevent overfitting, and use learning rate schedulers to adaptively adjust the learning rate during training for faster convergence and improved model performance. In some embodiments, during the training iterations, a learning rate scheduler may monitor the rate of change in loss. If the loss reduces slowly or plateaus, the scheduler may decrease the learning rate, allowing for finer adjustments to model parameters. On the other hand, if the model learns rapidly, the learning rate might be increased to expedite convergence. This adaptive approach may improve the efficiency of the training operations and/or may balance tradeoffs between speed and accuracy.

The term “batch normalization” is used herein to refer to a process for normalizing the inputs of the layers in a neural network to reduce or eliminate challenges associated with internal covariate shift, etc. Conventional neural networks perform many complex and resource-intensive batch normalization operations to improve the accuracy of their outputs. By back propagating the loss function in accordance with some embodiments, a neural network may forgo performing batch normalization operations without reducing accuracy of its outputs, thereby improving the performance and efficiency of the neural network and the computing devices on which it is deployed.

The LXM 482 and/or transformer architecture 484 may be used for more advanced tasks, such as contextual understanding of sensor data, predictive modeling, and handling sophisticated vehicle operations. The LXM 482 may incorporate specialized AI models that use embeddings to convert discrete tokens (e.g., sensor data points, etc.) into continuous vectors for processing to provide a contextual understanding of sensor data and predictive modeling across varied scenarios. The transformer architecture 484 may use self-attention mechanisms to process input data concurrently, weigh different segments of an input sequence differently during output generation, and perform tasks requiring comprehension of relationships between elements within a sequence. For example, the LXM 482 may convert discrete sensor data points into continuous vectors for a vehicle navigating a dynamic environment with multiple sensors providing real-time data about obstacles, traffic, and road conditions. These vectors may include or characterize contextual information about the vehicle's surroundings. For example, a sudden drop in a LiDAR sensor's reading may be translated into a continuous vector representing a potential obstacle ahead. Concurrently, the transformer architecture 484 may process a sequence of these vectors to understand their relationships. For example, the transformer architecture 484 may weigh inputs from a camera sensor that provides data suggesting a pedestrian is ahead and a LiDAR sensor that indicates an obstacle to infer that the “obstacle” is potentially the pedestrian. By recognizing the relationships between different sensor readings, the transformer aids in generating a more holistic and contextually accurate representation of the vehicle's environment. This combined knowledge, sourced from both the LXM 482 and the transformer 484, may be used to improve or adjust vehicle operations, such as maneuvering, braking, predicting pedestrian movements, etc.

The LSTM 486 and/or RNN 488 may be configured to process temporal sequential sensor data, capture temporal dependencies, etc. For example, the comparison component 446 may be configured to use the LSTM 486 or RNN 488 to handle the sequence of sensor data and derive meaningful patterns or discrepancies between the two self-driving sensor processing models (i.e., the low-end and complex sensor processing models). For example, during heavy rain, the complex sensor processing model may be more adept at identifying a pedestrian in a raincoat obscured by the downpour than the low-end model. As another example, at a complex intersection with multiple vehicles, pedestrians, and changing stoplight patterns, the complex sensor processing model may offer a more nuanced understanding of the sequence of events and more accurately predict traffic flow, the intention of pedestrians, or the expected behavior of other vehicles. The comparison component 446 may use the LSTM 486 or RNN 488 for a systematic and in-depth analysis of these patterns and discrepancies. These architectures can process the myriad of inputs from both models over time, highlighting the strengths and potential weaknesses of each.

The DNN 490 may include multiple layers of interconnected nodes or neurons that are collectively configured to processes sensor data to perform tasks such as line detection, object detection, and segmentation in both the low-end and complex sensor processing models. For example, the DNN 490 may include an input layer, multiple hidden layers, and an output layer. As data moves from one layer to the next, it undergoes transformations through weights, biases, and activation functions. The initial layers may capture basic features, such as edges or textures, and the deeper layers may recognize more complex patterns, such as shapes or objects.

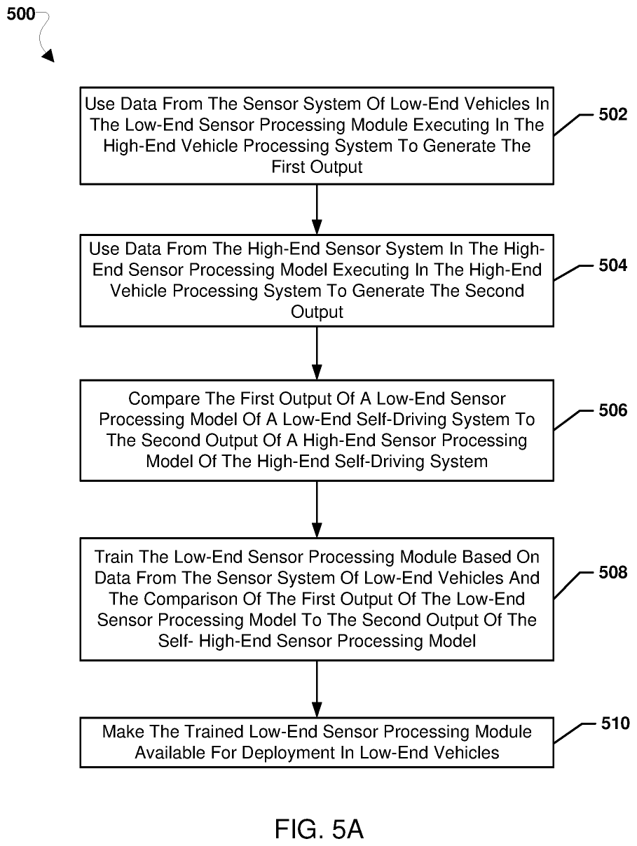

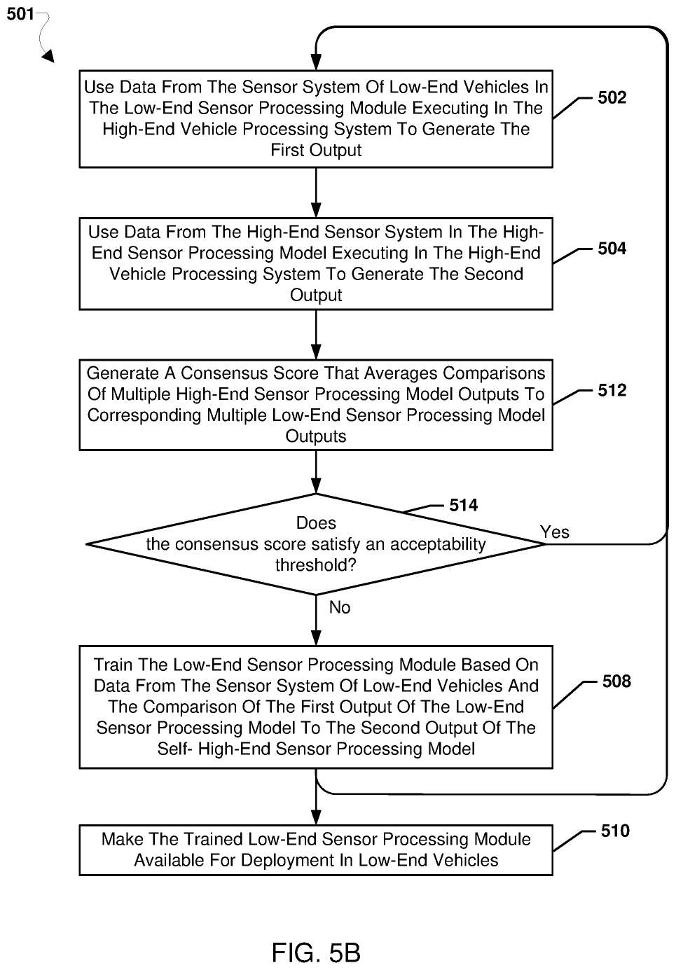

FIG. 5A is a process flow diagram illustrating an embodiment method 500 for training self-driving system modules for the second class of vehicles using sensors and self-driving systems of the first class of vehicle. With reference to FIGS. 1-5A, the method 500 may be performed in a first class vehicle processing system encompassing one or more processors (e.g., 164, 303, 304, 306, 307, 308, 310, 317, etc.), components or subsystems discussed in this application. Means for performing the functions of the operations in the method 500 may include a first class vehicle processing system including one or more of processors 164, 303, 304, 306, 307, 308, 310, 317, and other components described herein. Further, one or more processors of a first class vehicle processing system may be configured with software or firmware to perform some or all of the operations of the method 500. In order to encompass the alternative configurations enabled in various embodiments, the hardware implementing any or all of the method 500 is referred to herein as a “processing system.”

In block 502, the processing system may use data from the sensor system of the second class of vehicles in the sensor processing model for use in the second class of vehicles executing in the first class vehicle processing system to generate the first output. In various embodiments, the sensor processing model for use in the second class of vehicles may be one or more of line-detection models, object detection models, object detection segmentation models, human detection models, animal detection models, vehicle detection models and/or distance or depth estimation models.

In block 504, the processing system may use data from the complex sensor system in the complex sensor processing model executing in the first class vehicle processing system to generate the second output. In various embodiments, the complex sensor processing model may be one or more of line-detection models, object detection models, object detection segmentation models, human detection models, animal detection models, vehicle detection models and/or distance or depth estimation models.

In block 506, the processing system may compare the first output of the sensor processing model for use in the second class of vehicles of a low-end self-driving system to a second output of a complex sensor processing model of the self-driving system of the first class of vehicle for purposes of generating information for training the sensor processing model for use in the second class of vehicles. For purposes of training the sensor processing model for use in the second class of vehicles, the output of the low-end model may be treated as a forward pass through the model. By treating the output of the complex sensor processing model as a “ground truth,” the comparison made in block 506 may serve as an error calculation that results in an error or loss value. Non-limiting examples of the types of comparisons that may be performed in block 506 may include Mean Squared Error calculations for regression analysis (e.g., roadway following) or Cross-Entropy Loss calculations for classification analysis (e.g., object classification).

In block 508, the processing system may train the sensor processing model for use in the second class of vehicles based on data from the sensor system of the second class of vehicles and the comparison of the first output of the sensor processing model for use in the second class of vehicles to the second output of the complex sensor processing model. In some embodiments, such training may involve adjusting weights in a machine learning module of the sensor processing model for use in the second class of vehicles to reduce a difference identified in the comparison of the first output to the second output. In some embodiments, such training may involve training a machine learning module of the sensor processing model for use in the second class of vehicles executing in the first class vehicle processing system to reduce a knowledge distillation loss function based on the comparison.

As a non-limiting example, the training of the sensor processing model for use in the second class of vehicles performed in block 508 may use a knowledge distillation loss function such as:

$$Loss = {\sum }_{i = 1}^{n} ‖ {M}_{C} ( {X}_{i}^{R G B} , {X}_{i}^{L i D A R} ) - {M}_{S} ( {X}_{i}^{R G B} ) ‖$$

in which M_{C} and M_{S} indicate the first class model and second class model, respectively, and Xᵢ^{RGB} represents red-green-blue inputs from cameras, and XᵢLiDAR represents inputs from LiDAR sensors.

In some embodiments, the training of the sensor processing model for use in the second class of vehicles performed in block 508 may use the well-known methods of “backpropagation” of the results of the comparison made in block 506 to determine the gradient of the loss with respect to each weight in each layer of the neural network model. This may be accomplished using well know calculational methods, such as applying the chain rule, to obtain information on the direction and magnitude of change in each network connection weight that will reduces the loss (i.e., the loss value determined in the comparison made in block 506). In backpropagation, the gradient information for adjusting model weights is determined starting from the output layer of the model and moving backward through each neural network layer. After the gradients are calculated, optimization algorithms like Gradient Descent or its variations (e.g., Stochastic Gradient Descent, Adam, RMSprop, etc.) may be employed to update the weights and biases in the neural network layers. This training may be performed in an iterative manner to minimize the loss between the complex sensor processing model and the sensor processing model for use in the second class of vehicles (as determined in block 506). The result of such training in each training cycle (i.e., performance of blocks 502-508) may be a reduction in the difference in outputs between the sensor processing model for use in the second class of vehicles and the complex sensor processing model. This training, and thus the operations in blocks 502-508, may be repeated continuously or periodically as the first class vehicle operates until the comparison performed in block 506 indicates that the sensor processing model for use in the second class of vehicles exhibits acceptable performance for use in low-end self-driving systems.

In block 510, the processing system may make the trained sensor processing model for use in the second class of vehicles available for deployment in the second class of vehicles. In some embodiments, the processing system may transmit or otherwise upload the trained sensor processing model for use in the second class of vehicles to a remote server, such as a server that receives trained models from multiple the first class of vehicles, generates a consolidated sensor processing model for use in the second class of vehicles, and distributes the consolidated sensor processing model for use in the second class of vehicles to the second class of vehicles for use in their self-driving system. In some embodiments, the processing system may transmit at least a portion of the trained sensor processing model for use in the second class of vehicles to a remote server in a format that enables the remote server to deploy trained self-driving systems to the second class of vehicles. In some embodiments, the processing system may transmit a trained machine learning module of the trained sensor processing model for use in the second class of vehicles to the remote server. In some embodiments, the processing system may transmit at least some of the neural network connections and/or weights of the trained machine learning model. In some embodiments, the processing system may transmit at least a portion of the trained sensor processing model for use in the second class of vehicles to a remote server in a format that prevents disclosure of user privacy information, such as transmitting information in the trained machine learning module that does not include information related to the vehicle owner or driving patterns.

FIG. 5B is a process flow diagram illustrating another embodiment method 501 for training self-driving system modules for the second class of vehicles using sensors and self-driving systems of the first class of vehicle. With reference to FIGS. 1-5B, the method 501 may be performed in a computing device by a processing system encompassing one or more processors (e.g., 164, 303, 304, 306, 307, 308, 310, 317, etc.), components or subsystems discussed in this application. Means for performing the functions of the operations in the method 501 may include a processing system including one or more of processors 164, 303, 304, 306, 307, 308, 310, 317, and other components described herein. Further, one or more processors of a processing system may be configured with software or firmware to perform some or all of the operations of the method 501. In order to encompass the alternative configurations enabled in various embodiments, the hardware implementing any or all of the method 501 is referred to herein as a “processing system.”

In block 502, the processing system may use data from the sensor system of the second class of vehicles in the sensor processing model for use in the second class of vehicles executing in the first class vehicle processing system to generate the first output. As described, the sensor processing model for use in the second class of vehicles may be one or more of line-detection models, object detection models, object detection segmentation models, human detection models, animal detection models, vehicle detection models and/or distance or depth estimation models.

In block 504, the processing system may use data from the complex sensor system in the complex sensor processing model executing in the first class vehicle processing system to generate the second output. As described, the complex sensor processing model may be one or more of line-detection models, object detection models, object detection segmentation models, human detection models, animal detection models, vehicle detection models and/or distance or depth estimation models.

In block 512, the processing system may generating a consensus score that averages comparisons of multiple complex sensor processing model outputs to corresponding multiple sensor processing model for use in the second class of vehicles outputs. In some embodiments, the consensus score may be calculated as an average over time of differences between outputs of the complex sensor processing model and outputs of the sensor processing model for use in the second class of vehicles. In such embodiments, the larger average difference, the more training of the sensor processing model for use in the second class of vehicles may be required.

In a non-limiting example, the consensus score generated in block 512 may involve a calculation using a formula like:

$$Consensus score = \frac{( {C}_{1} * {S}_{1} + {C}_{2} * {S}_{2} + … + {C}_{n} * {S}_{n} )}{n}$$

in which C₁, C₂, . . . , Cₙ are the outputs from the complex sensor processing model, S₁, S₂, . . . , Sₙ are outputs from the sensor processing model for use in the second class of vehicles, and n is the number of data points used in the calculation. Again, these outputs may be any of various sensor processing model outputs, such as line detect, roadway detection, object detection, object detection segmentation, object classification, etc. Further, the consensus score generated in block 512 may be generated as a combination, average or distribution of consensus scores calculated for multiple different types of outputs and/or sensor processing models.

In determination block 514, the processing system may determine whether the consensus score satisfies an acceptability threshold. Such an acceptability threshold may be set (e.g., by a vehicle manufacturer or self-driving software provider) at a level of differences between complex sensor processing model and simplified sensor processing model outputs that can be safely accommodated by the low-end self-driving system. The acceptability threshold may depend on the type of output evaluated (e.g., line detect, roadway detection, object detection, object detection segmentation, object classification, etc.), capabilities of the low-end self-driving system, regulatory requirements imposed on self-driving vehicles, manufacturer/software provider policies, and/or vehicle owner settings or preferences.

In response to determining that consensus score satisfies the acceptability threshold (i.e., determination block 514=“Yes”), the processing system continue to perform the operations to generate and compare the first and second outputs of the simplified sensor processing model and complex sensor processing model in blocks 502, 504 and 512 as described. Thus, as long as the simplified sensor processing model is producing an output that within a threshold difference, training of the simplified sensor processing model may be suspended.

In response to determining that consensus score does not satisfy the acceptability threshold (i.e., determination block 514=“No”), the processing system may train the sensor processing model for use in the second class of vehicles based on data from the sensor system of the second class of vehicles and the comparison of the first output of the sensor processing model for use in the second class of vehicles to the second output of the complex sensor processing model in block 508, and make the trained model available to the second class of vehicles in block 510 as described for the method 500.

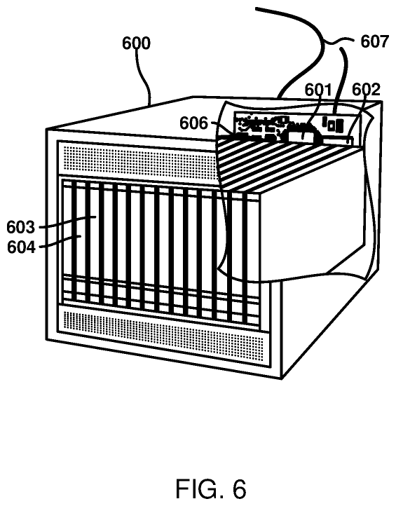

Some embodiments may be implemented in any of a variety of commercially available computing devices, such as the server computing device 600 illustrated in FIG. 6. Such a server device 600 may include a processor 601 coupled to volatile memory 602 and a large capacity nonvolatile memory, such as a disk drive 603. The server device 600 may also include a floppy disc drive, USB, etc. coupled to the processor 601. The server device 600 may also include network access ports 606 coupled to the processor 601 for establishing data connections with a network connection circuit 604 and a communication network 607 (e.g., an Internet protocol (IP) network) coupled to other communication system network elements.

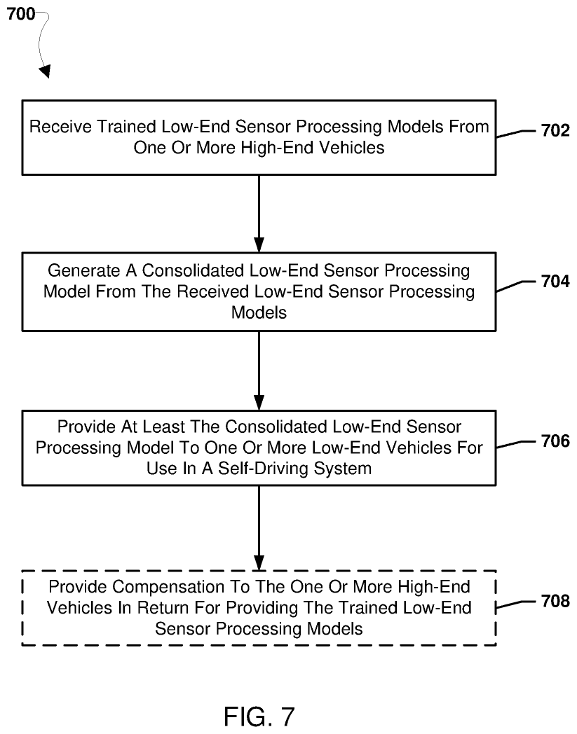

FIG. 7 is a process flow diagram illustrating another embodiment method 700 for generating self-driving systems for the second class of vehicles using trained modules for self-driving systems received from the first class of vehicles. With reference to FIGS. 1A-7, the method 700 may be performed in a server or similar computing device by one or more processors (e.g., 601). Means for performing the functions of the operations in the method 700 may include a processing system of the server including one or more of processors 601, memory 602 and other components described herein. Further, one or more processors of a processing system may be configured with software or firmware to perform some or all of the operations of the method 700. In order to encompass the alternative configurations enabled in various embodiments, the hardware implementing any or all of the method 700 is referred to herein as a “processing system.”

In block 702, the server may receiving trained sensor processing model for use in the second class of vehicles from one or more the first class of vehicles. In some embodiments, the processing system may receive trained models from each first class of vehicle upon completion of a training cycle. The server may receive trained models via over-the-air wireless communications with the first class of vehicles, or periodically via upload procedures, such as performed in dealerships, service centers, via home networks, and the like. Such wireless communications and upload procedures may identify the owner of the first class vehicle to enable providing compensation for such services as described with reference to block 708, but may do so in a manner that protects vehicle owner privacy information considering that trained models has the potential for revealing owner driving practices, routes, and schedules.

In block 704, the server may generate a consolidated sensor processing model for use in the second class of vehicles from the received sensor processing model for use in the second class of vehicles. In some embodiments, the consolidation processes may average the weights of neural network models to arrive at a single consolidated trained model. In some embodiments, the consolidation processes may involve statistical analyses, such as not including outlier models when generating consolidated sensor processing model for use in the second class of vehicles. In some embodiments, the processing system may generate a consolidated low-end self-driving model based upon the consolidated sensor processing model for use in the second class of vehicles.

In some embodiments, the server may use information regarding the operating area of the first class of vehicles that provided trained sensor processing model for use in the second class of vehicles to generate consolidated sensor processing model for use in the second class of vehicles that are focused on particular operating areas. Such embodiments may enable the server to deploy to the second class of vehicles a sensor processing model for use in the second class of vehicles that is particularly trained for the vehicle's operating area. Such an area-specific trained sensor processing model for use in the second class of vehicles may equip the second class of vehicles with self-driving systems that are able to navigate their operating area with enhanced capability for recognizing and maneuvering around particular roadway features in the operating area.

In block 706, the server may provide the consolidated sensor processing model for use in the second class of vehicles to one or more the second class of vehicles for use in a self-driving system. In some embodiments, the server may provide also (or alternatively) provide a consolidated low-end self-driving model to one or more the second class of vehicles. The consolidated low and sensor processing model and/or self-driving model may be installed in vehicles by the manufacturer. The distribution of model updates to the second class of vehicles after sale may be accomplished using over-the-air update procedures, or during periodic servicing of the vehicle in service centers, dealerships, etc.

In optional block 708, the processing system may provide compensation to the one or more the first class of vehicles in return for providing the trained sensor processing model for use in the second class of vehicles. Such compensation may be any form, including money or credits towards service or vehicle upgrades. Implementation examples are described in the following paragraphs. While some of the following implementation examples are described in terms of example methods, further example implementations may include: the example methods discussed in the following paragraphs implemented by a vehicle processing including one or more processors configured (e.g., with processor-executable instructions) to perform operations of the methods of the following implementation examples; the example methods discussed in the following paragraphs implemented by a vehicle including means for performing functions of the methods of the following implementation examples; and the example methods discussed in the following paragraphs may be implemented as a non-transitory processor-readable storage medium having stored thereon processor-executable instructions configured to cause one or more processors of a vehicle processing system to perform the operations of the methods of the following implementation examples.

Example 1. A method performed in a processing system of a first class of vehicle for training self-driving systems for a second class of vehicles using sensors and self-driving systems of the first class of vehicles that includes a complex sensor system and a sensor system of the second class of vehicles, including: comparing, in the vehicle processing system of the first class of vehicle, a first output of a sensor processing model for use in a self-driving system for the second class of vehicles to a second output of a complex sensor processing model of the self-driving system of the first class of vehicle; training the sensor processing model for use in the second class of vehicles based on data from the sensor system of the second class of vehicles and the comparison of the first output of the sensor processing model for use in the second class of vehicles to the second output of the complex sensor processing model; and making the trained sensor processing model available for deployment in the second class of vehicles.

Example 2. The method of example 1, further including: using data from the sensor system of the second class of vehicles in the sensor processing model for use in the second class of vehicles executing in the first class vehicle processing system to generate the first output; and using data from the complex sensor system in the complex sensor processing model executing in the first class vehicle processing system to generate the second output.

Example 3. The method of example 2, in which training the sensor processing model for use in the second class of vehicles based on data from the sensor system of the second class of vehicles and the comparison of the first output of the sensor processing model for use in the second class of vehicles to the second output of the complex sensor processing model comprises adjusting weights in a machine learning module of the sensor processing model for use in the second class of vehicles to reduce a difference identified in the comparison of the first output to the second output.

Example 4. The method of example 2, in which training the sensor processing model for use in the second class of vehicles based on data from the sensor system of the second class of vehicles and the comparison of the first output of the sensor processing model for use in the second class of vehicles to the second output of the complex sensor processing model includes training a machine learning module of the sensor processing model for use in the second class of vehicles executing in the first class vehicle processing system to reduce a knowledge distillation loss function based on the comparison.

Example 5. The method of any of examples 1-4, further including: periodically generating a consensus score that averages comparisons of multiple complex sensor processing model outputs to corresponding multiple outputs of the sensor processing model for use in the second class of vehicles; and performing the training of the sensor processing model for use in the second class of vehicles based on data from the sensor system of the second class of vehicles and the comparison of the first output of the sensor processing model for use in the second class of vehicles to the second output of the complex sensor processing model when the consensus score fails to satisfy an acceptability threshold.

Example 6. The method of any of examples 1-5, in which the sensor processing model for use in the second class of vehicles and the complex sensor processing model are one or more of line-detection models, object detection models, object detection segmentation models, human detection models, animal detection models, vehicle detection models or distance or depth estimation models.

Example 7. The method of any of examples 1-6, in which making the trained low-end self-driving system available for deployment in the second class of vehicles includes transmitting at least a portion of the trained sensor processing model for use in the second class of vehicles to a remote server in a format that enables the remote server to deploy trained self-driving systems to the second class of vehicles.

Example 8. The method of example 7, in which transmitting at least a portion of the trained sensor processing model for use in the second class of vehicles to the remote server includes transmitting a trained machine learning module of the trained sensor processing model for use in the second class of vehicles to the remote server.

Example 9. The method of example 7, in which transmitting at least a portion of the trained sensor processing model for use in the second class of vehicles to the remote server includes transmitting at least a portion of the trained sensor processing model for use in the second class of vehicles to a remote server in a format that prevents disclosure of user privacy information.

Implementation examples are described in the following paragraphs. While some of the following implementation examples are described in terms of example methods, further example implementations may include: the example methods discussed in the following paragraphs implemented by a server including one or more processors configured (e.g., with processor-executable instructions) to perform operations of the methods of the following implementation examples; the example methods discussed in the following paragraphs implemented by a server including means for performing functions of the methods of the following implementation examples; and the example methods discussed in the following paragraphs may be implemented as a non-transitory processor-readable storage medium having stored thereon processor-executable instructions configured to cause one or more processors of a server to perform the operations of the methods of the following implementation examples.

Example 10. A method of deploying self-driving systems trained in a first class of vehicles to a second class of vehicles, including: receiving trained sensor processing model for use in the second class of vehicles from one or more first class of vehicles; generating a consolidated sensor processing model for use in the second class of vehicles from the received sensor processing model for use in the second class of vehicles; and providing at least the consolidated sensor processing model for use in the second class of vehicles to one or more the second class of vehicles for use in a self-driving system.

Example 11. The method of example 10, further including providing compensation to owners of the one or more the first class of vehicles in return for providing the trained sensor processing model for use in the second class of vehicles.

Example 12. The method of example 10, further including generating a low-end self-driving system based on the consolidated sensor processing model for use in the second class of vehicles, in which providing at least the consolidated sensor processing model for use in the second class of vehicles to one or more second class of vehicles for use in a self-driving system includes providing the generated low-end self-driving system to one or more the second class of vehicles.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware used to implement the various illustrative logics, logical blocks, modules, and circuits described in connection with the embodiments disclosed herein may be implemented or performed by a processing system including, for example, a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processing system may include any conventional processor, controller, microcontroller, or state machine. A processing system may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features disclosed herein.

What is claimed is:

1. A method performed in a processing system of a first class of vehicle for training self-driving systems for a second class of vehicles using sensors and self-driving systems of the first class of vehicles that includes a complex sensor system and a sensor system of the second class of vehicles, comprising:
comparing, in the vehicle processing system of the first class of vehicle, a first output of a sensor processing model for use in a self-driving system for the second class of vehicles to a second output of a complex sensor processing model of the self-driving system of the first class of vehicle;
training the sensor processing model for use in the second class of vehicles based on data from the sensor system of the second class of vehicles and the comparison of the first output of the sensor processing model for use in the second class of vehicles to the second output of the complex sensor processing model; and
making the trained sensor processing model available for deployment in the second class of vehicles.

2. The method of claim 1, further comprising:
using data from the sensor system of the second class of vehicles in the sensor processing model for use in the second class of vehicles executing in the first class of vehicle processing system to generate the first output; and
using data from the complex sensor system in the complex sensor processing model executing in the first class of vehicle processing system to generate the second output.

3. The method of claim 2, wherein training the sensor processing model for use in the second class of vehicles based on data from the sensor system of the second class of vehicles and the comparison of the first output of the sensor processing model for use in the second class of vehicles to the second output of the complex sensor processing model comprises adjusting weights in a machine learning module of the sensor processing model for use in the second class of vehicles to reduce a difference identified in the comparison of the first output to the second output.

4. The method of claim 2, wherein training the sensor processing model for use in the second class of vehicles based on data from the sensor system of the second class of vehicles and the comparison of the first output of the sensor processing model for use in the second class of vehicles to the second output of the complex sensor processing model comprises training a machine learning module of the sensor processing model for use in the second class of vehicles executing in the processing system of the first class of vehicle to reduce a knowledge distillation loss function based on the comparison.

5. The method of claim 1, further comprising:
periodically generating a consensus score that averages comparisons of multiple complex sensor processing model outputs to corresponding multiple outputs of the sensor processing model for use in the second class of vehicles; and
performing the training of the sensor processing model for use in the second class of vehicles based on data from the sensor system of the second class of vehicles and the comparison of the first output of the sensor processing model for use in the second class of vehicles to the second output of the complex sensor processing model when the consensus score fails to satisfy an acceptability threshold.

6. The method of claim 1, wherein the sensor processing model for use in the second class of vehicles and the complex sensor processing model are one or more of line-detection models, object detection models, object detection segmentation models, human detection models, animal detection models, vehicle detection models, or distance or depth estimation models.

7. The method of claim 1, wherein making the trained self-driving system available for deployment in the second class of vehicles comprises transmitting at least a portion of the trained sensor processing model for use in the second class of vehicles to a remote server in a format that enables the remote server to deploy trained self-driving systems to the second class of vehicles.

8. The method of claim 7, wherein transmitting at least a portion of the trained sensor processing model for use in the second class of vehicles to the remote server comprises transmitting a trained machine learning module of the trained sensor processing model for use in the second class of vehicles to the remote server.

9. The method of claim 7, wherein transmitting at least a portion of the trained sensor processing model for use in the second class of vehicles to the remote server comprises transmitting at least a portion of the trained sensor processing model for use in the second class of vehicles to a remote server in a format that prevents disclosure of user privacy information.

10. A vehicle of a first class, comprising:
a complex sensor system;
a sensor system of the second class of vehicles;
a memory; and
a processing system coupled to the complex sensor system, the sensor system of the second class of vehicles, and the memory, wherein the processing system is configured to:
compare a first output of a sensor processing model for use in the second class of vehicles of a low-end self-driving system to a second output of a complex sensor processing model;
train the sensor processing model for use in the second class of vehicles based on data from the sensor system of the second class of vehicles and the comparison of the first output of the sensor processing model for use in the second class of vehicles to the second output of the complex sensor processing model; and
make the trained sensor processing model for use in the second class of vehicles available for deployment in the second class of vehicles.

11. The vehicle of claim 10, wherein the processing system is configured further to:
use data from the sensor system of the second class of vehicles in the sensor processing model for use in the second class of vehicles executing in the processing system to generate the first output; and
use data from the complex sensor system in the complex sensor processing model executing in the processing system to generate the second output.

12. The vehicle of claim 11, wherein the processing system is further configured to train the sensor processing model for use in the second class of vehicles based on data from the sensor system of the second class of vehicles and the comparison of the first output of the sensor processing model for use in the second class of vehicles to the second output of the complex sensor processing model by adjusting weights in a machine learning module of the sensor processing model for use in the second class of vehicles to reduce a difference identified in the comparison of the first output to the second output.

13. The vehicle of claim 11, wherein the processing system is further configured to train the sensor processing model for use in the second class of vehicles based on data from the sensor system of the second class of vehicles and the comparison of the first output of the sensor processing model for use in the second class of vehicles to the second output of the complex sensor processing model by training a machine learning module of the sensor processing model for use in the second class of vehicles executing in the processing system to reduce a knowledge distillation loss function based on the comparison.

14. The vehicle of claim 10, wherein the processing system is further configured to:
periodically generate a consensus score that averages comparisons of multiple complex sensor processing model outputs to corresponding multiple outputs of the sensor processing model for use in the second class of vehicles; and
perform the training of the sensor processing model for use in the second class of vehicles based on data from the sensor system of the second class of vehicles and the comparison of the first output of the sensor processing model for use in the second class of vehicles to the second output of the complex sensor processing model when the consensus score fails to satisfy an acceptability threshold.

15. The vehicle of claim 10, wherein the sensor processing model for use in the second class of vehicles and the complex sensor processing model are one or more of line-detection models, object detection models, object detection segmentation models, human detection models, animal detection models, vehicle detection models, or distance or depth estimation models.

16. The vehicle of claim 10, wherein the processing system is further configured to make the trained a low-end self-driving system available for deployment in the second class of vehicles by transmitting at least a portion of the trained sensor processing model for use in the second class of vehicles to a remote server in a format that enables the remote server to deploy trained self-driving systems to the second class of vehicles.

17. The vehicle of claim 16, wherein the processing system is further configured such that transmitting at least a portion of the trained sensor processing model for use in the second class of vehicles to the remote server comprises transmitting a trained machine learning module of the trained sensor processing model for use in the second class of vehicles to the remote server.

18. The vehicle of claim 16, wherein the processing system is further configured such that transmitting at least a portion of the trained sensor processing model for use in the second class of vehicles to the remote server comprises transmitting at least a portion of the trained sensor processing model for use in the second class of vehicles to a remote server in a format that prevents disclosure of user privacy information.

19. A method of deploying self-driving systems trained in a first class of vehicles to a second class of vehicles, comprising:
receiving trained sensor processing model for use in the second class of vehicles from one or more first class of vehicles;
generating a consolidated sensor processing model for use in the second class of vehicles from the received sensor processing model for use in the second class of vehicles; and
providing at least the consolidated sensor processing model for use in the second class of vehicles to one or more the second class of vehicles for use in a self-driving system.

20. The method of claim 19, further comprising providing compensation to the one or more first class of vehicles in return for providing the trained sensor processing model for use in the second class of vehicles.

21. The method of claim 19, further comprising generating a low-end self-driving system based on the consolidated sensor processing model for use in the second class of vehicles,
wherein providing at least the consolidated sensor processing model for use in the second class of vehicles to one or more of the second class of vehicles for use in a self-driving system comprises providing the generated low-end self-driving system to one or more the second class of vehicles.

22. A server, comprising:
a processing system configured to:
receive trained sensor processing model for use in a second class of vehicles from one or more first class of vehicles;
generate a consolidated sensor processing model for use in a second class of vehicles from the received sensor processing model for use in the second class of vehicles; and
provide at least the consolidated sensor processing model for use in the second class of vehicles to one or more second class of vehicles for use in a self-driving system.

23. The server of claim 22, wherein the processing system is further configure to provide compensation to owners of the one or more first class of vehicles in return for providing the trained sensor processing model for use in the second class of vehicles.

24. The server of claim 22, wherein the processing system is further configure to:
generate a low-end self-driving system based on the consolidated sensor processing model for use in the second class of vehicles; and
provide at least the consolidated sensor processing model for use in the second class of vehicles to one or more the second class of vehicles for use in a self-driving system by providing the generated low-end self-driving system to one or more the second class of vehicles.
